(19) United States
(12) Patent Application Publication
(10) Pub. No.: US 2012/0322677 A1
(43) Pub. Date: Dec. 20, 2012

(54) PREDICTING BENEFIT OF ANTI-CANCER THERAPY VIA ARRAY COMPARATIVE GENOMIC HYBRIDIZATION

(75) Inventors: Sabine Charlotte Linn, Amsterdam (NL); Petra Marleen Nederlof, Amsterdam (NL); Marieke Anne Vollebergh, Amsterdam (NL)

(73) Assignee: Stichting Het Nederlands Kanker Instituut, Amsterdam (NL)

(21) Appl. No.: 13/502,696

(22) PCT Filed: Oct. 19, 2010
(86) PCT No.: PCT/IB10/02870

§ 371 Date: Jul. 18, 2012

Related U.S. Application Data
(60) Provisional application No. 61/279,564, filed on Oct. 19, 2009.

(51) Int. Cl. C40B 30/04; C40B 40/06

(52) U.S. Cl. 506/9; 506/16

(57) ABSTRACT

Array comparative genomic hybridization classifiers, arrays comprising the classifiers, and related methods of using the same for predicting the therapeutic efficacy of anti-cancer therapy by detecting phenotypic genetic traits using comparative genomic hybridization are disclosed.

### CROSS-REFERENCE TO RELATED APPLICATIONS

This patent Cooperation Treaty patent application claims priority to U.S. Provisional Patent Application No. 61/279,564 filed Oct. 19, 2009, which is incorporated by reference herein for all purposes in its entirety.

### FIELD

Array comparative genomic hybridization classifiers, arrays comprising the classifiers, and related methods provided by the present disclosure may be used to predict a patient's response to anti-cancer therapy by detecting phenotypic genetic traits using comparative genomic hybridization.

### BACKGROUND

Breast cancer is the most frequently occurring cancer among women in the western world. It is a heterogeneous cancer disease, consisting of several subtypes. Molecular biology has greatly enhanced our understanding of the heterogeneity of breast cancer, but few molecular tumor features are actually used in the clinic to guide the choice of a systemic treatment strategy.

(Neo)adjuvant systemic therapy has become a widely used treatment strategy for patients with early, or locally advanced, breast cancer. Despite its early and late toxicities, this treatment strategy reduces the risk of breast cancer relapse and mortality by approximately half.

In spite of this advantage, a disadvantage to the use of (neo)adjuvant systemic therapy is the lack of predictive tests to individualize the choice of certain combinations of drugs for an individual breast cancer patient to ensure maximal benefit with minimal toxicity. For example, for highly toxic adjuvant treatment regimens, such as high dose alkylating chemotherapy with hematopoietic stem-cell rescue, the survival benefit when compared with standard chemotherapy is approximately 10% for patients with 10 or more positive axillary lymph nodes. It would thus be advantageous to be able to target those 10% of patients who would benefit from high dose alkylating chemotherapy. However, no such predictive test presently exists. Because of the relatively high toxicity and the low level of efficacy in unselected breast cancer patients, alkylating agents are not commonly used in the treatment of breast cancer, with the exception of cyclophosphamide.

Alkylating chemotherapy and platinating agents work by causing interstrand DNA crosslinking, which cause DNA double strand breaks. In normal cells, these double strand breaks are repaired by a process called homologous recombination. If this process is unavailable or impaired, a situation referred to as “homologous recombination deficiency” exists and alternative, error-prone DNA repair mechanisms take over, leading to genomic instability. The breast cancer genes BRCA1 and BRCA2 are involved in normal homologous recombination and tumors of patients carrying germ-line inactivating mutations in one or both of these genes show homologous recombination deficiency. BRCA1 and BRCA2 can also be inactivated in sporadic cancers as well, a phenomenon sometimes referred to as BRCA-likeness (or BRCAness). Emerging preclinical evidence shows that breast cancers with a defective DNA repair system, such as a mutation in the BRCA1 or BRCA2 genes, may be extremely sensitive to DNA damaging agents, such as platinum compounds and bifunctional alkylating agents. It therefore appears that patients with breast cancers harboring a defective DNA repair system may specifically benefit from high dose alkylating chemotherapy, a DNA double strand break (DSB)-inducing regimen.

Tumors with homologous recombination deficiency have been shown to be particularly sensitive to DNA double strand break (DSB)-inducing agents, such as alkylators and platinum drugs or platinating agents. Both classes of drugs are employed in metastatic breast cancer. The novel poly(ADP-ribose)polymerase inhibitors (PARP inhibitors) are specifically effective in homologous recombination deficient tumors as well, and have shown impressive activity in clinical studies recently. Unfortunately, no clinical tests exist which can reliably determine homologous recombination deficiency in tumor biopsies.

### SUMMARY

Therefore, methods of predicting the therapeutic efficacy of anti-cancer therapies by identifying patients who would benefit from one or more anti-cancer therapies, including, without limitation, DNA double strand break-inducing regimens such as high dose alkylating chemotherapy, by reliably determining homologous recombination deficiency in tumor biopsies, and by identifying patients with breast cancers harboring a defective DNA repair system, are useful.

In various aspects, the present disclosure is based on the discovery that certain chromosomal copy number aberrations in tumor cells allow tumors to be classified as BRCA2-like tumors or non-BRCA2-like (originally called ‘sporadic’) tumors. The classification of a tumor in this manner allows for the prospective prediction of responsiveness of the patient from which the tumor was removed to anti-cancer therapy.

In a first aspect, methods for using a BRCA2 aCGH classifier to detect genomic copy number variations in a test sample, as compared to a reference sample, in the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28 are disclosed. The methods comprise detecting genomic copy number variations in a test sample, wherein the copy number variations are detected in at least one, or in some embodiments a plurality, of the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28, wherein a variation in copy number at any one or more of the genomic loci, as compared to the number of copies of DNA from a reference sample, classifies the cell sample as from either a BRCA2-like tumor or a non-BRCA2-like tumor, and wherein such classification can be used to predict an individual subject's response to anti-cancer therapy. In some embodiments, the genomic copy number variations are detected at all 25 genomic loci. In some embodiments, the genomic copy number variations are detected at a number of genomic loci selected from greater than 1, greater than 2, greater than 3, greater than 4, greater than 5, greater than 6, greater than 7, greater than 8, greater than 9, greater than 10, greater than 11, greater than 12, greater than 13, greater than 14, greater than 15, greater than 16, greater than 17, greater than 18, greater than 19, greater than 20, greater than 21, greater than 22, greater than 23, and greater than 24. In some embodiments, the genomic copy number variations are detected at a number of genomic loci selected from less than 25, less than 24, less than 23, less than 22, less than 21, less than 20, less than 19, less than 18, less than 17, less than 16, less than 15, less than 14, less than 13, less than 12, less than 11, less than 10, less than 9, less than 8, less than 7, less than 6, less than 5, less than 4, less than 3, and less than 2.

In a second aspect, methods for using a BRCA2 aCGH classifier to detect genomic copy number variations in a test sample, as compared to a reference sample, in the genomic loci selected from 4p13-12, 13q12.2-21.1, 13q31.3-33.1, 14q23.2-32.33, 16q12.1-21, 17q11.1-12 and 17q21.2-21.31 are disclosed. The methods comprise detecting genomic copy number variations in a test sample, wherein the copy number variations are detected in one, or in some embodiments a plurality, of the genomic loci selected from 4p13-12, 13q12.2-21.1, 13q31.3-33.1, 14q23.2-32.33, 16q12.1-21, 17q11.1-12 and 17q21.2-21.31, and wherein a variation in copy number at any one or more of the genomic loci, as compared to the number of copies of DNA from a reference sample, classifies the cell sample as from either a BRCA2-like tumor or a non-BRCA2-like tumor, and wherein such classification can be used to predict whether an individual will benefit from anti-cancer therapy. In some embodiments, the genomic copy number variations are detected at all 7 genomic loci. In some embodiments, the genomic copy number variations are detected at a number of genomic loci selected from greater than 1, greater than 2, greater than 3, greater than 4, greater than 5, and greater than 6. In some embodiments, the genomic copy number variations are detected at a number of genomic loci selected from less than 7, less than 6, less than 5, less than 4, less than 3, and less than 2.

In a third aspect, methods for using a BRCA2 aCGH classifier to detect genomic copy number variations in a test sample, as compared to a reference sample, are disclosed, wherein the classifier comprises at least one of the BAC clones set forth in FIG. 2. The methods comprise detecting genomic copy number variations in a test sample, wherein the copy number variations are detected using at least one, or in some embodiments a plurality, of the BAC clones of FIG. 2, wherein a variation in copy number at any one or more of the BAC clones, as compared to the number of copies of DNA from a reference sample, classifies the cell sample as from either a BRCA2-like tumor or a non-BRCA2-like tumor, and wherein such classification can be used to predict whether an individual will benefit from anti-cancer therapy. In some embodiments, the genomic copy number variations are detected using all 704 of the BAC clones set forth in FIG. 2. In some embodiments, the genomic copy number variations are detected using a number of the BAC clones set forth in FIG. 2 selected from greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, and greater than 700. In some embodiments, the genomic copy number variations are detected using a number of the BAC clones set forth in FIG. 2 selected from less than 704, less than 700, less than 675, less than 650, less than 625, less than 600, less than 575, less than 550, less than 525, less than 500, less than 475, less than 450, less than 425, less than 400, less than 375, less than 350, less than 325, less than 300, less than 275, less than 250, less than 225, less than 200, less than 175, less than 150, less than 125, less than 100, less than 75, less than 50, less than 25, less than 20, and less than 10.

In a fourth aspect, methods for using a BRCA2 aCGH classifier to detect genomic copy number variations in a test sample, as compared to a reference sample, in the genomic loci selected from 6p25.3-11.1, 6q12-13 and 13q31.3-33.1 are disclosed. The methods comprise detecting genomic copy number variations in a test sample, wherein the copy number variations are detected in at least one, or in some embodiments a plurality, of the genomic loci selected from 6p25.3-11.1, 6q12-13 and 13q31.3-33.1, wherein an increase in copy number at any one or more of the genomic loci, as compared to the number of copies of DNA from a reference sample, classifies the cell sample as from a BRCA2-like tumor, and wherein such classification can be used to predict whether an individual will benefit from anti-cancer therapy. In some embodiments, the genomic copy number variations are detected at all 3 genomic loci. In some embodiments, the genomic copy number variations are detected at a number of genomic loci selected from greater than 1 and greater than 2. In some embodiments, the genomic copy number variations are detected at a number of genomic loci selected from less than 3, and less than 2.

In a fifth aspect, methods for using a BRCA2 aCGH classifier to detect genomic copy number variations in a test sample, as compared to a reference sample, in the genomic loci selected from 10q22.3-26.13, 13q12.2-21.1 and 14q23.2-32.33 are disclosed. The methods comprise detecting genomic copy number variations in a test sample, wherein the copy number variations are detected in at least one, or in some embodiments a plurality, of the genomic loci selected from 10q22.3-26.13, 13q12.2-21.1 and 14q23.2-32.33, wherein a decrease in copy number at any one or more of the genomic loci, as compared to the number of copies of DNA from a reference sample, classifies the cell sample as from a BRCA2-like tumor, and wherein such classification can be used to predict whether an individual will benefit from anti-cancer therapy. In some embodiments, the genomic copy number variations are detected at all 3 genomic loci. In some embodiments, the genomic copy number variations are detected at a number of genomic loci selected from greater than 1 and greater than 2. In some embodiments, the genomic copy number variations are detected at a number of genomic loci selected from less than 3, and less than 2.

In a sixth aspect, methods for using a BRCA2 aCGH classifier to detect genomic copy number variations in a test sample, as compared to a reference sample, in the genomic locus 16p12.3-11.2 are disclosed. The methods comprise detecting genomic copy number variations in a test sample, wherein the copy number variations are detected at the genomic locus 16p12.3-11.2, wherein an increase in copy number at 16p12.3-11.2, as compared to the number of copies of DNA from a reference sample, classifies the cell sample as from a non-BRCA2-like tumor, and wherein such classification can be used to predict whether an individual will benefit from anti-cancer therapy.

In a seventh aspect, methods for using a BRCA2 aCGH classifier to detect genomic copy number variations in a test sample, as compared to a reference sample, in one, or a plurality, of the genomic loci selected from 2q36.3-37.1, 4p13-12, 16q12.1-21, 17q11.1-12 and 17q21.2-21.31 are disclosed. The methods comprise detecting genomic copy number variations in a test sample, wherein the copy number variations are detected in at least one, or in some embodiments a plurality, of the genomic loci selected from 2q36.3-37.1, 4p13-12, 16q12.1-21, 17q11.1-12 and 17q21.2-21.31, wherein a decrease in copy number at any one or more of the genomic loci, as compared to the number of copies of DNA from a reference sample, classifies the cell sample as from a non-BRCA2-like tumor, and wherein such classification can be used to predict whether an individual will benefit from anti-cancer therapy. In some embodiments, the genomic copy number variations are detected at all 5 genomic loci. In some embodiments, the genomic copy number variations are detected at a number of genomic loci selected from greater than 1, greater than 2, greater than 3, and greater than 4. In some embodiments, the genomic copy number variations are detected at a number of genomic loci selected from less than 5, less than 4, less than 3, and less than 2.

### BRIEF DESCRIPTION OF THE DRAWINGS

Those skilled in the art will understand that the drawings, described herein, are for illustration purposes only. The drawings are not intended to limit the scope of the present disclosure.

FIG. 1A depicts the BRCA2-like genomic loci used to identify breast cancers with a BRCA2-deficient DNA repair system. ‘SPQR’ means non-BRCA2-like (‘sporadic’).

FIG. 1B depicts a subset of the BRCA2-like genomic loci of FIG. 1A. ‘SPOR’ means non-BRCA2-like (‘sporadic’).

FIG. 2 depicts exemplary BAC clones that may be used to detect, or to generate probes to detect, copy number aberrations in the genomic loci of FIGS. 1A and 1B.

FIG. 3 depicts the Kaplan-Meier curves for recurrence-free and overall survival of BRCA2-like^{CGH} and non-BRCA2-like^{CGH} breast cancer patients randomized between conventional adjuvant chemotherapy and high-dose, platinum-based adjuvant chemotherapy in the validation series of Example 2.

FIG. 4 depicts patient characteristics distributed by treatment arm and BRCA2-classification of the stage-III series for Example 3.

### DETAILED DESCRIPTION

### Definitions

“Anti-cancer therapy” means any one, or a plurality, of therapies and/or drugs used to treat cancer, or any combinations thereof, including a) homologous recombination deficiency-targeted drugs and/or treatments; and b) drugs or treatments that directly or indirectly cause double strand DNA breaks. This definition includes, without limitation, high dose platinum-based alkylating chemotherapy, platinum compounds, thiotepa, cyclophosphamide, iphosphamide, nitrosureas, nitrogen mustard derivatives, mitomycins, epipodophyllotoxins, camptothecins, anthracyclines, poly(ADP-ribose)polymerase (PARP) inhibitors, ionizing radiation, ABT-888, olaparib (AZT-2281), gemcitabine, CEP-9722, AG014699, AG014699 with Temozolomide, and BSI-201.

“Array” refers to an arrangement, on a substrate surface, of multiple nucleic acid probes (as defined herein) of predetermined identity. In various embodiments, the sequences of each of the multiple nucleic acid probes are known. In general, an array comprises a plurality of target elements, each target element comprising one or more nucleic acid probes immobilized on one or more solid surfaces, to which sample nucleic acids can be hybridized. In various embodiments, each individual probe is immobilized to a designated, discrete location (i.e., a defined location or assigned position) on the substrate surface. In various embodiments, each nucleic acid probe is immobilized to a discrete location on an array and each has a sequence that is either specific to, or characteristic of, a particular genomic locus. A nucleic acid probe is specific to, or characteristic of, a genomic locus when it contains a nucleic acid sequence that is unique to that genomic locus. Such a probe preferentially hybridizes to a nucleic acid made from that genomic locus, relative to nucleic acids made from other genomic loci.

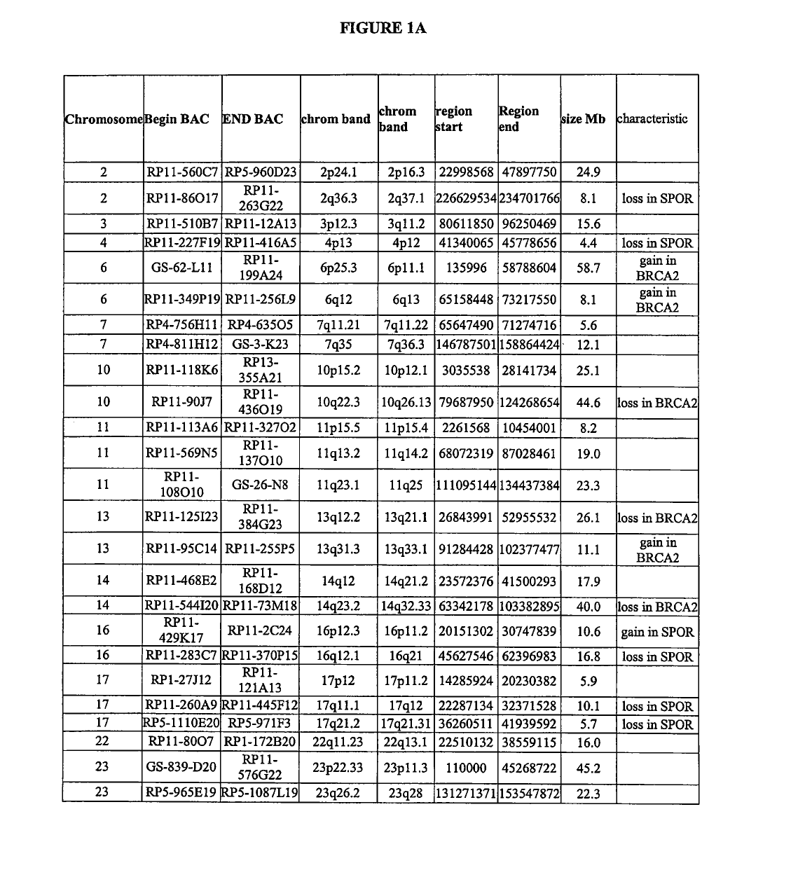

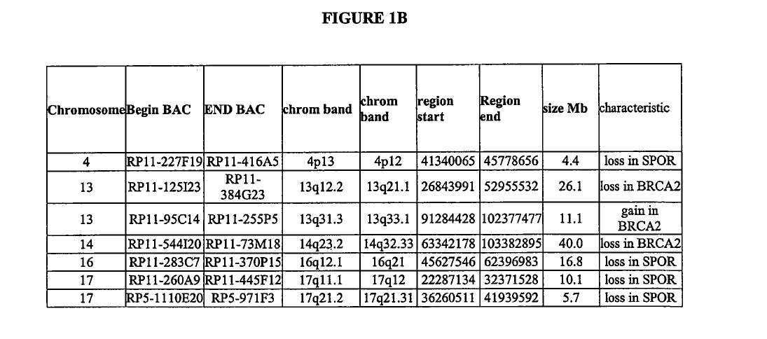

The nucleic acid probes can contain sequence(s) from specific genes or clones. In various embodiments, at least some of the nucleic acid probes contain sequences from any one or more of the specific genomic regions recited in FIG. 1A. In various embodiments, at least some of the nucleic acid probes contain sequences from any one or more of the specific genomic regions recited in FIG. 1B. In various embodiments, at least some of the nucleic acid probes contain sequences of known, reference genes or clones. In various embodiments, the nucleic acid probes in a single array contain both sequences from any one or more of the specific genomic regions recited in FIG. 1A and sequences of known, reference genes or clones. In various embodiments, the nucleic acid probes in a single array contain both sequences from any one or more of the specific genomic regions recited in FIG. 1B and sequences of known, reference genes or clones.

The probes may be arranged on the substrate in a single density, or in varying densities. The density of each of the probes can be varied to accommodate certain factors such as, for example, the nature of the test sample, the nature of a label used during hybridization, the type of substrate used, and the like. Each probe may comprise a mixture of nucleic acids of varying lengths and, thus, varying sequences. For example, a single probe may contain more than one copy of a cloned nucleic acid, and each copy may be broken into fragments of different lengths. Each length will thus have a different sequence.

The length, sequence and complexity of the nucleic acid probes may be varied. In various embodiments, the length, sequence and complexity are varied to provide optimum hybridization and signal production for a given hybridization procedure, and to provide the required resolution among different genes or genomic locations.

“BRCA2-like tumor” means a tumor having cells containing a mutation of the BRCA2 locus or a deficiency in the homologous recombination-dependent double strand break DNA repair pathway that alters BRCA2 activity or function, either directly or indirectly.

“CGH” or “Comparative Genomic Hybridization” refers generally to molecular-cytogenetic techniques for the analysis of copy number changes, gains and/or losses, in the DNA content of a given subject's DNA. CGH can be used to identify chromosomal alterations, such as unbalanced chromosomal changes, in any number of cells including, for example, cancer cells. In various embodiments, CGH is utilized to detect one or more chromosomal amplifications and/or deletions of regions between a test sample and a reference sample.

“Chromosomal locus” refers to a specific, defined portion of a chromosome.

“Genome” refers to all nucleic acid sequences, coding and non-coding, present in each cell type of a subject. The term also includes all naturally occurring or induced variation of these sequences that may be present in a mutant or disease variant of any cell type, including, for example, tumor cells. Genomic DNA and genomic nucleic acids are thus nucleic acids isolated from a nucleus of one or more cells, and include nucleic acids derived from, isolated from, amplified from, or cloned from genomic DNA, as well as synthetic versions of all or any part of a genome.

For example, the human genome consists of approximately 3.0×10⁹ base pairs of DNA organized into 46 distinct chromosomes. The genome of a normal human diploid somatic cell consists of 22 pairs of autosomes (chromosomes 1 to 22) and either chromosomes X and Y (male) or a pair of X chromosomes (female) for a total of 46 chromosomes. A genome of a cancer cell may contain variable numbers of each chromosome in addition to deletions, rearrangements and amplification of any sub-chromosomal region or DNA sequence.

“Genomic locus” refers to a specific, defined portion of a genome.

“HBOC tumors” refers to tumors present in a group of patients with a high risk for BRCA2-like breast cancer (patients from Hereditary Breast and Ovarian Cancer families), who display a negative screen result for BRCA1 and/or BRCA2 mutation. Such patients have a family history that include at least two diagnoses for breast cancer and one diagnosis for ovarian cancer.

“Hybridization” refers to the binding of two single stranded nucleic acids via complementary base pairing. Extensive guides to the hybridization of nucleic acids can be found in: Tijssen, Laboratory Techniques in Biochemistry and Molecular Biology-Hybridization with Nucleic Acid Probes Part I, Ch. 2, “Overview of principles of hybridization and the strategy of nucleic acid probe assays” (1993), Elsevier, N.Y.; and Sambrook et al., Molecular Cloning: A Laboratory Manual (3rd ed.) Vol. 1-3 (2001), Cold Spring Harbor Laboratory, Cold Spring Harbor Press, N.Y. The phrases “hybridizing specifically to”, “specific hybridization”, and “selectively hybridize to”, refer to the preferential binding, duplexing, or hybridizing of a nucleic acid molecule to a particular probe under stringent conditions. The term “stringent conditions” refers to hybridization conditions under which a probe will hybridize preferentially to its target subsequence, and to a lesser extent, or not at all, to other sequences in a mixed population (e.g., a DNA preparation from a tissue biopsy). “Stringent hybridization” and “stringent hybridization wash conditions” are sequence-dependent and are different under different environmental parameters.

Generally, highly stringent hybridization and wash conditions are selected to be about 5° C. lower than the thermal melting point (Tm) for a specific sequence at a defined ionic strength and pH. The Tm is the temperature at which 50% of the target sequence hybridizes to a perfectly matched probe. Very stringent conditions are selected to be equal to the Tm for a particular probe. Often, a high stringency wash is preceded by a low stringency wash to remove background probe signal. An example of stringent hybridization conditions for hybridization of complementary nucleic acids which have more than 100 complementary residues on an array is 42° C. using standard hybridization solutions, with the hybridization being carried out overnight. An example of highly stringent wash conditions is a 0.15 M NaCl wash at 72° C. for 15 minutes. An example of stringent wash conditions is a wash in 0.2× Standard Saline Citrate (SSC) buffer at 65° C. for 15 minutes. An example of a medium stringency wash for a duplex of, for example, more than 100 nucleotides, is 1×SSC at 45° C. for 15 minutes. An example of a low stringency wash for a duplex of, for example, more than 100 nucleotides, is 4× to 6×SSC at 40° C. for 15 minutes.

“Micro-array” refers to an array that is miniaturized so as to require microscopic examination for visual evaluation. In various embodiments, the arrays used in the methods of the present disclosure are micro-arrays.

“Nucleic acid” refers to a deoxyribonucleotide or ribonucleotide in either single- or double-stranded form and includes all nucleic acids comprising naturally occurring nucleotide bases as well as nucleic acids containing any and/or all analogues of natural nucleotides. This term also includes nucleic acid analogues that are metabolized in a manner similar to naturally occurring nucleotides, but at rates that are improved for the purposes desired. This term also encompasses nucleic-acid-like structures with synthetic backbone analogues including, without limitation, phosphodiester, phosphorothioate, phosphorodithioate, methylphosphonate, phosphoramidate, alkyl phosphotriester, sulfamate, 3′-thioacetal, methylene(methylimino), 3′-N-carbamate, morpholino carbamate, and peptide nucleic acids (PNAs) (see, e.g.: “Oligonucleotides and Analogues, a Practical Approach,” edited by F. Eckstein, IRL Press at Oxford University Press (1991); “Antisense Strategies,” Annals of the New York Academy of Sciences, Volume 600, Eds. Baserga and Denhardt (NYAS 1992); Milligan (1993) J. Med. Chem. 36:1923-1937; and “Antisense Research and Applications” (1993, CRC Press)). PNAs contain non-ionic backbones, such as N-(2-aminoethyl)glycine units. Phosphorothioate linkages are described in: WO 97/03211; WO 96/39154; and Mata (1997) Toxicol. Appl. Pharmacol. 144:189-197. Other synthetic backbones encompassed by this term include methyl-phosphonate linkages or alternating methyl-phosphonate and phosphodiester linkages (Strauss-Soukup (1997) Biochemistry 36: 8692-8698), and benzyl-phosphonate linkages (Samstag (1996) Antisense Nucleic Acid Drug Dev 6: 153-156).

“Probe” or “nucleic acid probe” refer to one or more nucleic acid fragments whose specific hybridization to a sample can be detected. In various embodiments, probes are arranged on a substrate surface in an array. The probe may be unlabelled, or it may contain one or more labels so that its binding to a nucleic acid can be detected. In various embodiments, a probe can be produced from any source of nucleic acids from one or more particular, pre-selected portions of a chromosome including, without limitation, one or more clones, an isolated whole chromosome, an isolated chromosome fragment, or a collection of polymerase chain reaction (PCR) amplification products.

In some embodiments, the probe may be a member of an array of nucleic acids as described in WO 96/17958. Techniques capable of producing high density arrays can also be used for this purpose (see, e.g., Fodor (1991) Science 767-773; Johnston (1998) Curr. Biol. 8: R171-R174; Schummer (1997) Biotechniques 23: 1087-1092; Kern (1997) Biotechniques 23: 120-124; and U.S. Pat. No. 5,143,854).

The sequence of the probes can be varied. In various embodiments, the probe sequence can be varied to produce probes that are substantially identical to the probes disclosed herein, but that retain the ability to hybridize specifically to the same targets or samples as the probe from which they were derived.

“Reference sample” refers to nucleic acids comprising sequences whose quantity or degree of representation, copy number, and/or sequence identity are known. Such nucleic acids serve as a reference to which one or more test samples are compared.

“Sample” refers to a material, or mixture of materials, containing one or more components of interest. Samples include, but are not limited to, material obtained from an organism and may be directly obtained from a source, such as from a biopsy or from a tumor, or indirectly obtained such as after culturing and/or processing.

“Test sample” refers to nucleic acids comprising sequences whose quantity or degree of representation, copy number, and/or sequence identity are unknown. In various embodiments, the present disclosure is directed to the detection of the quantity or degree of representation, copy number, and/or sequence identity of one or more test samples.

Reference is now made in detail to certain embodiments of arrays and methods. The disclosed embodiments are not intended to be limiting of the claims. To the contrary, the claims are intended to cover all alternatives, modifications, and equivalents.

### Arrays, Micro-Arrays and Probes

In various aspects, the present disclosure relates to the determination of copy number changes in the DNA content of a given test sample, as compared to one or more reference samples. In some embodiments, the copy number changes comprise gains or increases in the DNA content of a test sample. In some embodiments, the copy number changes comprise losses or decreases in the DNA content of a test sample. In some embodiments, the copy number changes comprise both gains or increases and losses or decreases in the DNA content of a test sample.

Determination of copy number changes can be determined by hybridizations that are performed on a solid support. For example, probes that selectively hybridize to specific chromosomal regions can be spotted onto a surface. In various aspects, the spots of probes are placed in an ordered pattern, or array, and the pattern is recorded to facilitate correlation of results. Once an array is generated, one or more test samples can be hybridized to the array. In various aspects, arrays comprise a plurality of nucleic acid probes immobilized to discrete spots (i.e., defined locations or assigned positions) on a substrate surface.

Thus, in several aspects, copy number changes of genomic loci are analyzed in an array-based approach. In some embodiments, copy number changes of genomic loci are analyzed using comparative genomic hybridization. In some embodiments, copy number changes of genomic loci are analyzed using array-based comparative genomic hybridization.

Any of a variety of arrays may be used. A number of arrays are commercially available for use from Vysis Corporation (Downers Grove, III), Spectral Genomics Inc. (Houston, Tex.), and Affymetrix Inc. (Santa Clara, Calif.). Arrays can also be custom made for one or more hybridizations.

Methods of making and using arrays are well known in the art (see, e.g., Kern et al., Biotechniques (1997), 23:120-124; Schummer et al., Biotechniques (1997), 23:1087-1092; Solinas-Toldo et al., Genes, Chromosomes & Cancer (1997), 20: 399-407; Johnston, Curr. Biol. (1998), 8: R171-R174; Bowtell, Nature Gen. (1999), Supp. 21:25-32; Watson et al., Biol. Psychiatry (1999), 45: 533-543; Freeman et al., Biotechniques (2000), 29: 1042-1046 and 1048-1055; Lockhart et al., Nature (2000), 405: 827-836; Cuzin, Transfus. Clin. Biol. (2001), 8:291-296; Zarrinkar et al., Genome Res. (2001), 11: 1256-1261; Gabig et al., Acta Biochim. Pol. (2001), 48: 615-622; and Cheung et al., Nature (2001), 40: 953-958; see also, e.g., U.S. Pat. Nos. 5,143,854; 5,434,049; 5,556,752; 5,632,957; 5,700,637; 5,744,305; 5,770,456; 5,800,992; 5,807,522; 5,830,645; 5,856,174; 5,959,098; 5,965,452; 6,013,440; 6,022,963; 6,045,996; 6,048,695; 6,054,270; 6,258,606; 6,261,776; 6,277,489; 6,277,628; 6,365,349; 6,387,626; 6,458,584; 6,503,711; 6,516,276; 6,521,465; 6,558,907; 6,562,565; 6,576,424; 6,587,579; 6,589,726; 6,594,432; 6,599,693; 6,600,031; and 6,613,893).

Substrate surfaces suitable for use in the generation of an array can be made of any rigid, semi-rigid or flexible material that allows for direct or indirect attachment (i.e., immobilization) of nucleic acid probes to the substrate surface. Suitable materials include, without limitation, cellulose (see, e.g., U.S. Pat. No. 5,068,269), cellulose acetate (see, e.g., U.S. Pat. No. 6,048,457), nitrocellulose, glass (see, e.g., U.S. Pat. No. 5,843,767), quartz and/or other crystalline substrates such as gallium arsenide, silicones (see, e.g., U.S. Pat. No. 6,096,817), plastics and plastic copolymers (see, e.g., U.S. Pat. Nos. 4,355,153; 4,652,613; and 6,024,872), membranes and gels (see, e.g., U.S. Pat. No. 5,795,557), and paramagnetic or supramagnetic microparticles (see, e.g., U.S. Pat. No. 5,939,261). When fluorescence is to be detected, arrays comprising cyclo-olefin polymers may be used (see, e.g., U.S. Pat. No. 6,063,338). The presence of reactive functional chemical groups (such as, for example, hydroxyl, carboxyl, and amino groups) present on the surface of the substrate material can be used to directly or indirectly attach nucleic acid probes to the substrate surface.

More than one copy of each nucleic acid probe may be spotted onto an array. For example, each nucleic acid probe may be spotted onto an array once, in duplicate, in triplicate, or more, depending on the desired application. Multiple spots of the same probe allows for assessment of the reproducibility of the results obtained.

Related nucleic acid probes may also be grouped together, in probe elements, on an array. For example, a single probe element may include a plurality of spots of related nucleic acid probes, which are of different lengths but that comprise substantially the same sequence or that are derived from the sequence of a specific genomic locus. Alternatively, a single probe element may include a plurality of spots of related nucleic acid probes that are fragments of different lengths resulting from digestion of more than one copy of a cloned nucleic acid. An array may contain a plurality of probe elements and probe elements may be arranged on an array at different densities.

Array-immobilized nucleic acid probes may be nucleic acids that contain sequences from genes (e.g., from a genomic library) including, for example, sequences that collectively cover a substantially complete genome, or any one or more subsets of a genome. In various embodiments, the sequences of the nucleic acid probes on an array comprise those for which comparative copy number information is desired. In some embodiments, to obtain DNA sequence copy number information across an entire genome, an array comprising nucleic acid probes covering a whole genome or a substantially complete genome is used. In some embodiments, at least one relevant genomic locus has been determined and is used in an array, such that there is no need for genome-wide hybridization. In some embodiments, a plurality of relevant genomic loci have been determined and are used in an array, such that there is no need for genome-wide hybridization. In some embodiments, the array comprises a plurality of specific nucleic acid probes that originate from a discrete set of genes or genomic loci and whose copy number, in association with the type of condition or tumor is to be tested, is known. Additionally, the array may comprise nucleic acid probes that will serve as positive or negative controls. In some embodiments, the array comprises a plurality of nucleic acid sequences derived from karyotypically normal genomes.

The probes may be generated by any number of known techniques (see, e.g., Tijssen, Laboratory Techniques in Biochemistry and Molecular Biology-Hybridization with Nucleic Acid Probes Part I, Ch. 2, “Overview of principles of hybridization and the strategy of nucleic acid probe assays” (1993), Elsevier, N.Y.; Sambrook et al., Molecular Cloning: A Laboratory Manual (3rd ed.) Vol. 1-3 (2001), Cold Spring Harbor Laboratory, Cold Spring Harbor Press, N.Y.; Innis (Ed.) “PCR Strategies” (1995), Academic Press: New York, N.Y.; and Ausubel (Ed.), “Short Protocols in Molecular Biology” 5th Ed. (2002), John Wiley & Sons). Nucleic acid probes may be obtained and manipulated by cloning into various vehicles. They may be screened and re-cloned or amplified from any source of genomic DNA.

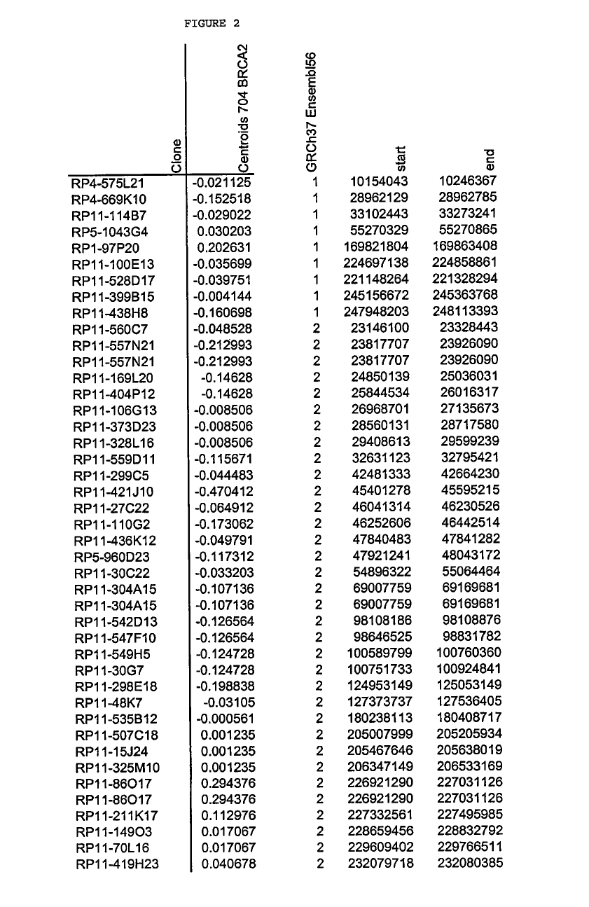

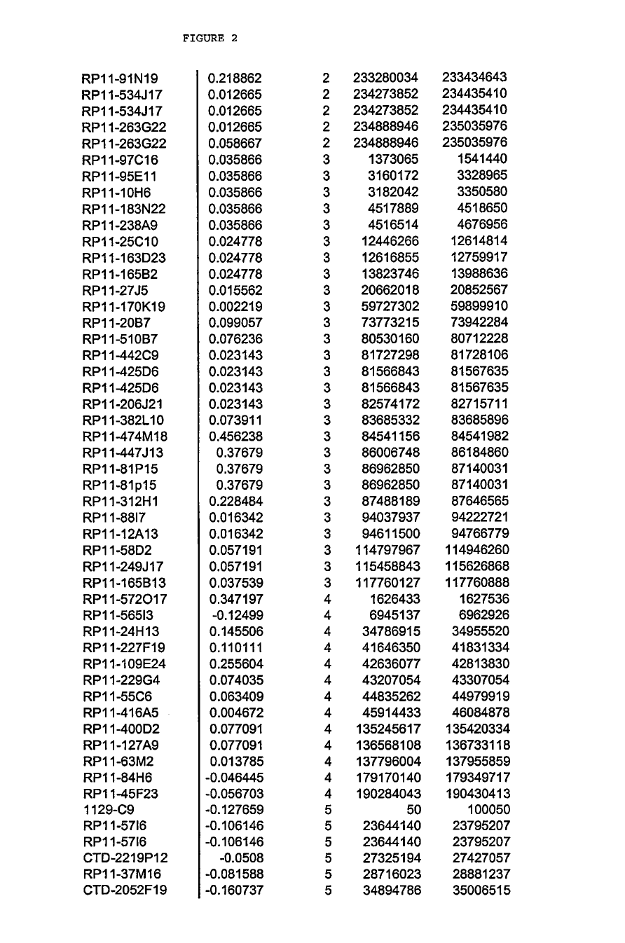

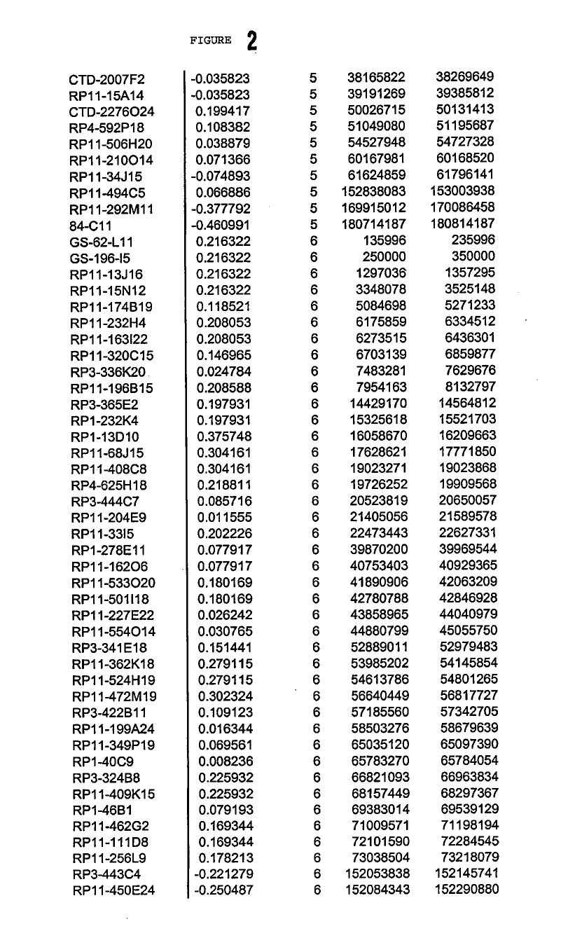

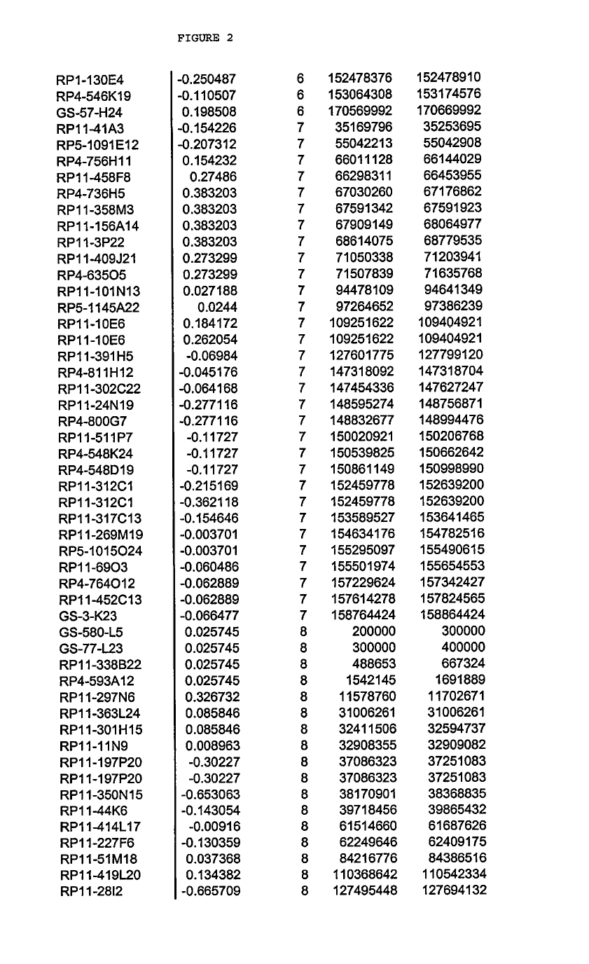

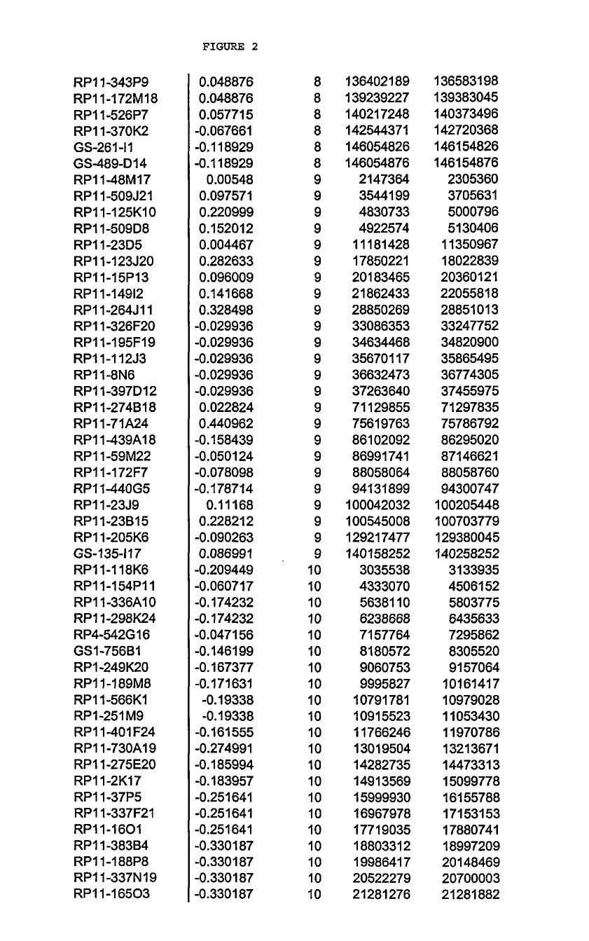

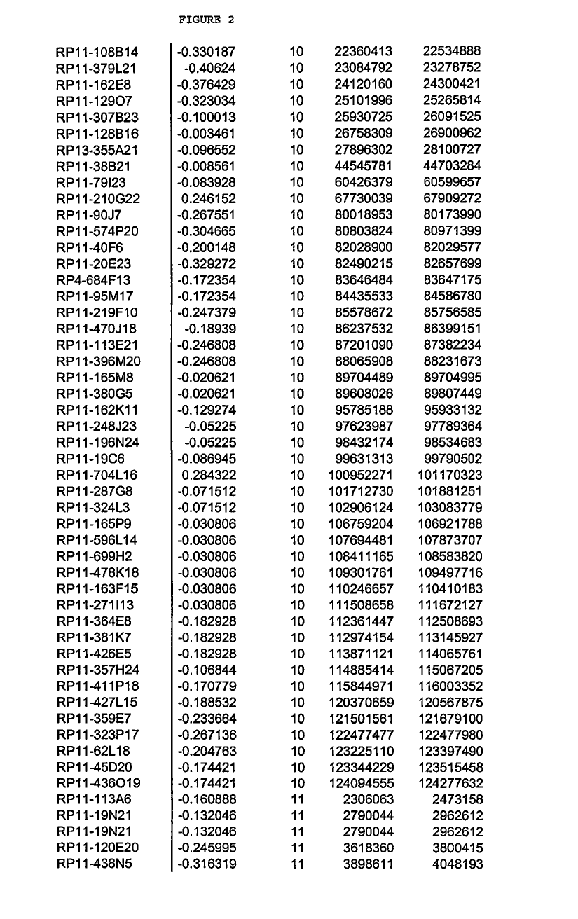

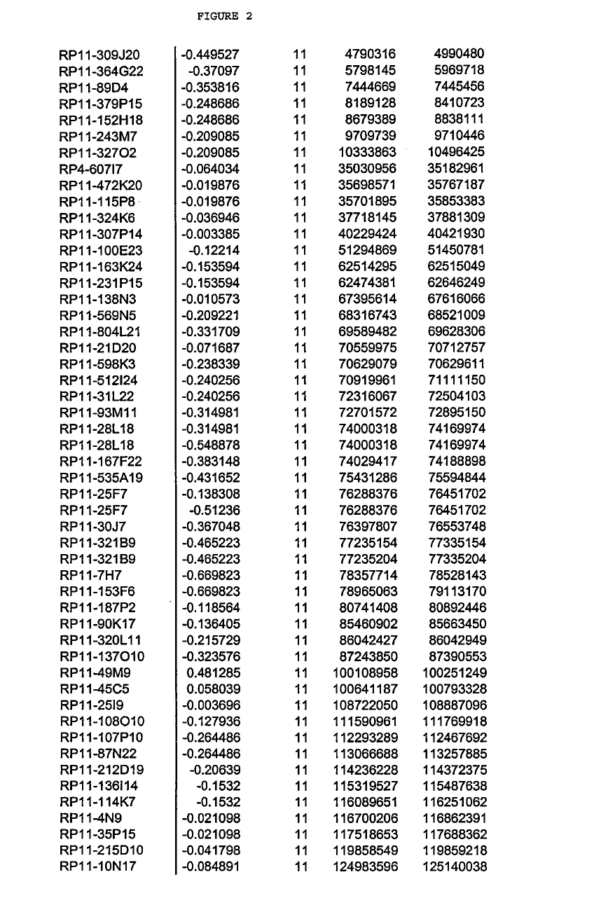

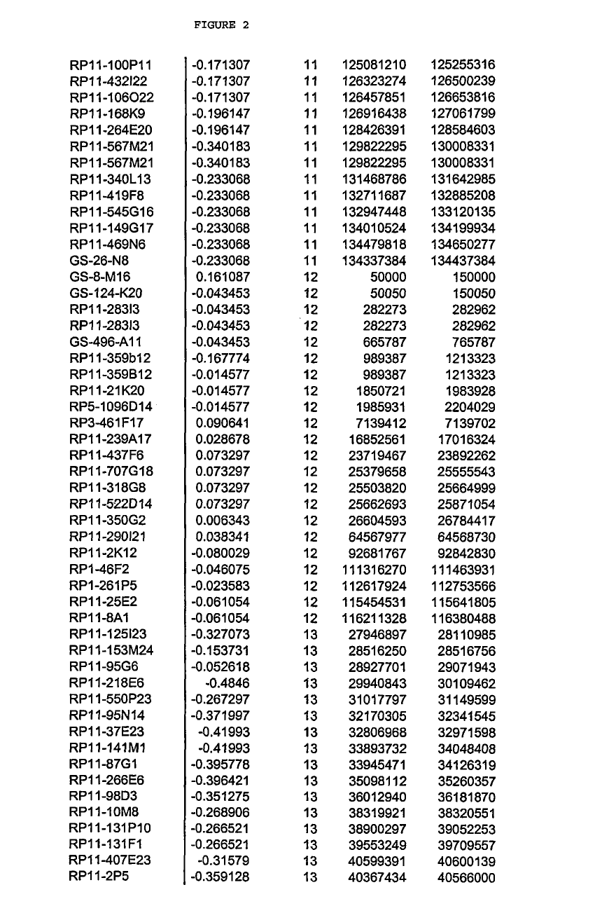

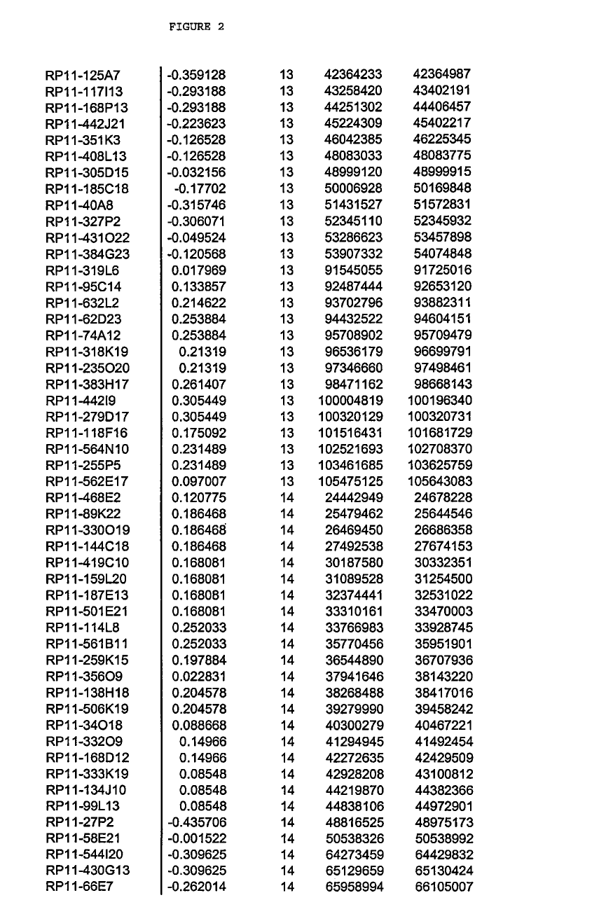

Nucleic acid probes may also be obtained and manipulated by cloning into vehicles including, for example, recombinant viruses, cosmids, or plasmids. Nucleic acid probes may also be synthesized in vitro by chemical techniques (see, e.g., Nucleic Acids Res. (1997), 25: 3440-3444; Blommers et al., Biochemistry (1994), 33: 7886-7896; and Frenkel et al., Free Radic. Biol. Med. (1995), 19: 373-380). Probes may vary in size from synthetic oligonucleotide probes and/or PCR-type amplification primers of a few base pairs in length to artificial chromosomes of more than 1 megabases in length. In various embodiments, probes comprise at least 10, at least 12, at least 15, at least 18, at least 20, at least 22, at least 30, at least 50 or at least 100 contiguous nucleotides of a sequence present in a BAC clone set forth in FIG. 2. In various embodiments, probes also comprise at least 10, at least 12, at least 15, at least 18, at least 20, at least 22, at least 30, at least 50 or at least 100 contiguous nucleotides of a sequence present in one or more reference samples. In some embodiments, probes comprise a sequence that is unique in a genome. In some embodiments, probes comprise a sequence that is unique in the human genome.

Probes may be obtained from any number of commercial sources. For instance, several P1 clones are available from the DuPont P1 library (see, e.g., Shepard et al., Proc. Natl. Acad. Sci. USA (1994), 92: 2629), and available commercially from Incyte Corporation (Wilmington, Del.). Various libraries spanning entire chromosomes are available commercially from Clontech Laboratories, Inc. (Mountain View, Calif.), or from the Los Alamos National Laboratory (Los Alamos, Calif.). In various aspects, the present disclosure relates to the use of the human 3600 BAC/PAC genomic clone set, covering the full human genome at 1 Mb spacing, obtained from the Wellcome Trust Sanger Institute (Hinxton, Cambridge, UK).

In some embodiments, the nucleic acid probes are derived from mammalian artificial chromosomes (MACs) and/or human artificial chromosomes (HACs), which can contain inserts from about 5 to 400 kilobases (kb) (see, e.g., Roush, Science (1997), 276: 38-39; Rosenfeld, Nat. Genet. (1997), 15: 333-335; Ascenzioni et al., Cancer Lett. (1997), 118: 135-142; Kuroiwa et al., Nat. Biotechnol. (2000), 18: 1086-1090; Meija et al., Am. J. Hum. Genet. (2001), 69: 315-326; and Auriche et al., EMBO Rep. (2001), 2: 102-107).

In some embodiments, the nucleic acid probes are derived from satellite artificial chromosomes or satellite DNA-based artificial chromosomes (SATACs). SATACs can be produced by inducing de novo chromosome formation in cells of varying mammalian species (see, e.g., Warburton et al., Nature (1997), 386: 553-555; Csonka et al., J. Cell. Sci. (2000), 113: 3207-3216; and Hadlaczky, Curr. Opin. Mol. Ther. (2001), 3: 125-132).

In some embodiments, the nucleic acid probes are derived from yeast artificial chromosomes (YACs), 0.2-1 megabses in size. YACs have been used for many years for the stable propagation of genomic fragments of up to one million base pairs in size (see, e.g., Feingold et al., Proc. Natl. Acad. Sci. USA (1990), 87:8637-8641; Adam et al., Plant J. (1997), 11: 1349-1358; Tucker et al., Gene (1997), 199: 25-30; and Zeschnigk et al., Nucleic Acids Res. (1999), 27: E30).

In some embodiments, the nucleic acid probes are derived from bacterial artificial chromosomes (BACs) up to 300 kb in size. BACs are based on the E. coli F factor plasmid system and are typically easy to manipulate and purify in microgram quantities (see, e.g., Asakawa et al., Gene (1997), 191: 69-79; and Cao et al., Genome Res. (1999), 9: 763-774).

In some embodiments, the nucleic acid probes are derived from P1 artificial chromosomes (PACs), about 70-100 kb in size. PACs are bacteriophage P1-derived vectors (see, e.g., Ioannou et al., Nature Genet. (1994), 6: 84-89; Boren et al., Genome Res. (1996), 6: 1123-1130; Nothwang et al., Genomics (1997), 41: 370-378; Reid et al., Genomics (1997), 43: 366-375; and Woon et al., Genomics (1998), 50: 306-316).

In some embodiments, the array comprises a series of separate wells or chambers on the substrate surface, into which probes may be immobilized as described herein. The probes can be immobilized in the separate wells or chambers and hybridization can take place within the wells or chambers. In various embodiments, the arrays can be selected from chips, microfluidic chips, microtiter plates, Petri dishes, and centrifuge tubes. Robotic equipment has been developed for these types of arrays that permit automated delivery of reagents into the separate wells or chambers which allow the amount of the reagents used per hybridization to be sharply reduced. Examples of chip and microfluidic chip techniques can be found, for example, in U.S. Pat. No. 5,800,690; Orchid, “Running on Parallel Lines” New Scientist (1997); McCormick et al., Anal. Chem. (1997), 69:2626-30; and Turgeon, “The Lab of the Future on CD-ROM?” Medical Laboratory Management Report. December 1997, p. 1.

In some embodiments, arrays may be generated by isolating DNA from one or more artificial chromosomes, such as for example BACs, according to standard procedures. For example, in some embodiments, DNA can be isolated from one or more BACs using a Qiawell plasmid kit (Qiagen, Chatsworth, Calif.). Total DNA can be amplified from the insert sites of the BACs via degenerate oligonucleotide primed PCR using a set of degenerate primers with a C6-NH₂ modification at their 5′ end for covalent attachment to a substrate surface. The substrates may be any type suitable for such use including, for example, CODELINK™ glass slides (Corning, Cambridge, UK). Covalent attachment to the substrate can occur via the manufacturer's suggested protocols, or via other detailed protocols (such as those described in Pinkel et al., Nature Genetics (1998), 20:207-211) with some modifications (such as those described in Alers et al. 1999). The DNA obtained after PCR amplification can then be spotted onto the substrate surface for covalent attachment thereto. The DNA may be spotted as a single site, in duplicate or in triplicate on the substrate surface.

### BRCA2 Arrays

In various aspects, the present disclosure relates to the use of a BRCA2 array to identify breast cancers with a deficient homologous recombination-dependent double strand break DNA repair system due to BRCA2 dysfunction and to thus identify patients, from whom the cancers have been excised, who will be highly sensitive to certain anti-cancer therapy. Therefore, in various aspects, the present disclosure relates to the use of a BRCA2 array comprising the unique BRCA2 aCGH profile disclosed herein to prospectively optimize the therapeutic efficacy of anti-cancer therapy in an individual subject by detecting phenotypic genetic traits associated with deficiencies in the BRCA2 gene. In further aspects, the present disclosure relates to the use of a BRCA2 array comprising the unique BRCA2 aCGH profile disclosed herein to prospectively optimize the therapeutic efficacy of anti-cancer therapy in an individual subject by detecting phenotypic genetic traits associated with deficiencies in non-BRCA2 genes, wherein the deficiencies negatively affect the homologous recombination-dependent double strand break DNA repair pathway of which BRCA2 is a component.

In various embodiments, a BRCA2 array comprising a BRCA2 aCGH profile for identifying individual subjects who will experience a therapeutic benefit from anti-cancer therapy, is provided. In various aspects, arrays provided by the present disclosure, which in some embodiments are BRCA2 arrays, can comprise at least one, or in some embodiments a plurality, of the BAC clones of FIG. 2 immobilized on a substrate surface. In various aspects, arrays provided by the present disclosure, which in some embodiments are BRCA2 arrays, can comprise at least one, or in some embodiments a plurality, of the BAC clones of FIG. 2 immobilized to discrete spots on a substrate surface. In some embodiments, an array comprises all 704 of the BAC clones set forth in FIG. 2 immobilized on a substrate surface. In some embodiments, an array comprises all 704 of the BAC clones set forth in FIG. 2, immobilized to a plurality of discrete spots on a substrate surface. In some embodiments, arrays provided by the present disclosure comprise a number of the BAC clones set forth in FIG. 2 selected from greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675 and greater than 700. In some embodiments, the BAC clones comprising the arrays of the preceding sentence are immobilized to a plurality of discrete spots on a substrate surface. In some embodiments, arrays provided by the present disclosure comprise a number of the BAC clones set forth in FIG. 2 selected from less than 704, less than 700, less than 675, less than 650, less than 625, less than 600, less than 575, less than 550, less than 525, less than 500, less than 475, less than 450, less than 425, less than 400, less than 375, less than 350, less than 325, less than 300, less than 275, less than 250, less than 225, less than 200, less than 175, less than 150, less than 125, less than 100, less than 75, less than 50, less than 25, less than 20, and less than 10. In some embodiments, the BAC clones comprising the arrays of the preceding sentence are immobilized to a plurality of discrete spots on a substrate surface. In various aspects, arrays provided by the present disclosure can also comprise at least one, or in some embodiments a plurality, of nucleic acid probes from a reference sample immobilized on a substrate surface. In various aspects, arrays provided by the present disclosure can also comprise at least one, or in some embodiments a plurality, of nucleic acid probes from a reference sample immobilized to discrete spots on a substrate surface. In some embodiments, a BRCA2 array is used to detect BRCA2-like genomic copy number variations in a test sample, as compared to a reference sample, at one, or a plurality, of the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28. In some embodiments, a BRCA2 array is used to detect BRCA2-like genomic copy number variations in a test sample, as compared to a reference sample, at one, or a plurality, of the genomic loci selected from 4p13-12, 13q12.2-21.1, 13q31.3-33.1, 14q23.2-32.33, 16q12.1-21, 17q11.1-12 and 17q21.2-21.31. In each of the aforementioned embodiments, detection of genomic copy number variations in the test sample, as compared to the reference sample, classifies the subject from whom the test sample was excised as an individual who will experience a therapeutic benefit from anti-cancer therapy.

In some embodiments, a BRCA2 array is used to detect an increase in genomic copy numbers in a test sample, as compared to a reference sample, at one, or a plurality, of the genomic loci selected from 6p25.3-11.1, 6q12-13 and 13q31.3-33.1. In some embodiments, a BRCA2 array is used to detect a decrease in genomic copy numbers in a test sample, as compared to a reference sample, at one, or a plurality, of the genomic loci selected from 10q22.3-26.13, 13q12.2-21.1 and 14q23.2-32.33. In each of the aforementioned embodiments, detection of genomic copy number variations in the test sample, as compared to the reference sample, the subject from whom the test sample was excised as an individual who will experience a therapeutic benefit from anti-cancer therapy.

In some embodiments, a BRCA2 array is used to detect an increase in genomic copy numbers in a test sample, as compared to a reference sample, at the genomic locus 16p12.3-11.2. In some embodiments, a BRCA2 array is used to detect a decrease in genomic copy numbers in a test sample, as compared to a reference sample, at one, or a plurality, of the genomic loci selected from 2q36.3-37.1, 4p13-12, 16q12.1-21, 17q11.1-12 and 17q21.2-21.31. In each of the aforementioned embodiments, detection of genomic copy number variations in the test sample, as compared to the reference sample, classifies the subject from whom the test sample was excised as an individual who will experience a therapeutic benefit from anti-cancer therapy.

The genomic loci may be detected individually, or in any combination of two or more loci. In some embodiments, a BRCA2 array is used that is capable of detecting BRCA2-like genomic copy number variations in all 25 of the above-listed chromosomal loci. In some embodiments, a BRCA2 array is used that is capable of detecting BRCA2-like genomic copy number variations at a number of the above-listed genomic loci selected from greater than 1, greater than 2, greater than 3, greater than 4, greater than 5, greater than 6, greater than 7, greater than 8, greater than 9, greater than 10, greater than 11, greater than 12, greater than 13, greater than 14, greater than 15, greater than 16, greater than 17, greater than 18, greater than 19, greater than 20, greater than 21, greater than 22, greater than 23, and greater than 24. In some embodiments, a BRCA2 array is used that is capable of detecting BRCA2-like genomic copy number variations at a number of the above-listed genomic loci selected from less than 25, less than 24, less than 23, less than 22, less than 21, less than 20, less than 19, less than 18, less than 17, less than 16, less than 15, less than 14, less than 13, less than 12, less than 11, less than 10, less than 9, less than 8, less than 7, less than 6, less than 5, less than 4, less than 3, and less than 2. In some embodiments, a BRCA2 array is used that is capable of detecting BRCA2-like genomic copy number variations in all 25 of the BRCA2-like genomic loci set forth in FIG. 1A. In some embodiments, a BRCA2 array is used that is capable of detecting BRCA2-like genomic copy number variations in all 7 of the BRCA2-like genomic loci set forth in FIG. 1B. In some embodiments, a BRCA2 array is used that is capable of detecting BRCA2-like genomic copy number variations in at least one, or a plurality, of the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28. In some embodiments, a BRCA2 array is used that is capable of detecting BRCA2-like genomic copy number variations in at least one, or a plurality, of the genomic loci selected from 4p13-12, 13q12.2-21.1, 13q31.3-33.1, 14q23.2-32.33, 16q12.1-21, 17q11.1-12 and 17q21.2-21.31. In some embodiments, a BRCA2 array is used that is capable of detecting BRCA2-like genomic copy number variations in at least one, or a plurality, of the genomic loci selected from 6p25.3-11.1, 6q12-13 and 13q31.3-33.1. In some embodiments, a BRCA2 array is used that is capable of detecting BRCA2-like genomic copy number variations in at least one, or a plurality, of the genomic loci selected from 10q22.3-26.13, 13q12.2-21.1 and 14q23.2-32.33. In some embodiments, a BRCA2 array is used that is capable of detecting BRCA2-like genomic copy number variations in at the genomic locus 16p12.3-11.2. In some embodiments, a BRCA2 array is used that is capable of detecting BRCA2-like genomic copy number variations in at least one, or a plurality, of the genomic loci selected from 2q36.3-37.1, 4p13-12, 16q12.1-21, 17q11.1-12 and 17q21.2-21.31. In each of the aforementioned embodiments, detection of BRCA2-like genomic copy number variations classifies the test sample as from either a BRCA2-like tumor or from a sporadic tumor and classifies the subject from whom the test sample was excised as an individual who will or will not experience a therapeutic benefit from anti-cancer therapy.

The BRCA2 arrays comprise at least one probe. In various embodiments, the BRCA2 arrays comprise a plurality of probes. In some embodiments, the BRCA2 arrays comprise a plurality of probes, wherein the probes comprise nucleic acid sequences derived from BAC clones. The BRCA2-like genomic loci set forth in FIG. 1A are bounded by the BAC probes set forth in FIG. 2. The BRCA2-like genomic loci set forth in FIG. 1B are bounded by a sub-set of the BAC probes set forth in FIG. 2. In some embodiments, arrays capable of detecting BRCA2-like genomic copy number variations comprise at least one, or a plurality, probes derived from the BAC clones of FIG. 2. The BAC clones set forth in FIG. 2 are not intended to be limiting in any way, and other probes within the BRCA2-like genomic loci of FIGS. 1A and 1B can also be used in the BRCA2 arrays. In some embodiments, arrays capable of detecting BRCA2-like genomic copy number variations comprise all 704 of the BAC clones set forth in FIG. 2. In some embodiments, arrays capable of detecting BRCA2-like genomic copy number variations comprise a number of the BAC clones set forth in FIG. 2 selected from greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, and greater than 700. In some embodiments, arrays capable of detecting BRCA2-like genomic copy number variations comprise a number of the BAC clones set forth in FIG. 2 selected from less than 704, less than 700, less than 675, less than 650, less than 625, less than 600, less than 575, less than 550, less than 525, less than 500, less than 475, less than 450, less than 425, less than 400, less than 375, less than 350, less than 325, less than 300, less than 275, less than 250, less than 225, less than 200, less than 175, less than 150, less than 125, less than 100, less than 75, less than 50, less than 25, less than 20, and less than 10.

In some embodiments, a BRCA2 array capable of detecting BRCA2-like genomic copy number variations comprises at least one, or a plurality, of probes that independently hybridize to a genomic locus selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28. In some embodiments, a BRCA2 array capable of detecting BRCA2-like genomic copy number variations comprises at least one, or a plurality, of probes that independently hybridize to a genomic locus selected from 4p13-12, 13q12.2-21.1, 13q31.3-33.1, 14q23.2-32.33, 16q12.1-21, 17q11.1-12 and 17q21.2-21.31. In some embodiments, a BRCA2 array capable of detecting BRCA2-like genomic copy number variations comprises at least one, or a plurality, of probes that independently hybridize to a genomic locus selected from 6p25.3-11.1, 6q12-13 and 13q31.3-33.1. In some embodiments, a BRCA2 array capable of detecting BRCA2-like genomic copy number variations comprises at least one, or a plurality, of probes that independently hybridize to a genomic locus selected from 10q22.3-26.13, 13q12.2-21.1 and 14q23.2-32.33. In some embodiments, a BRCA2 array capable of detecting BRCA2-like genomic copy number variations comprises at least one, or a plurality, of probes that independently hybridize to the genomic locus 16p12.3-11.2. In some embodiments, a BRCA2 array capable of detecting BRCA2-like genomic copy number variations comprises at least one, or a plurality, of probes that independently hybridize to a genomic locus selected from 2q36.3-37.1, 4p13-12, 16q12.1-21, 17q11.1-12 and 17q21.2-21.31. In these embodiments, the number of probes used can be determined as described above, the probes are as defined above and/or the probes may be obtained in methods as described above.

In some embodiments, BRCA2 arrays capable of detecting BRCA2-like genomic copy number variations comprise at least one, or a plurality, of probes, wherein the probes comprise at least one, or a plurality of the distinct BAC clones of FIG. 2. In some embodiments, BRCA2 arrays capable of detecting BRCA2-like genomic copy number variations comprise at least one, or a plurality of probes, wherein the probes comprise at least one, or a plurality, of the BAC clones of FIG. 2, and wherein the probes specifically hybridize to at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24 or at least 25 of the genomic loci set forth in FIG. 1A. In some embodiments, BRCA2 arrays capable of detecting BRCA2-like genomic copy number variations comprise a plurality of probes, wherein the nucleic acid sequences of the probes are unique to the genomic loci set forth in FIG. 1A. In some embodiments, BRCA2 arrays capable of detecting BRCA2-like genomic copy number variations comprise a plurality of probes, wherein the probes comprise a plurality of BAC clones specific to all of the genomic loci set forth in FIG. 1A. In some embodiments, BRCA2 arrays capable of detecting BRCA2-like genomic copy number variations comprise at least one, or a plurality of probes, wherein the probes comprise at least one, or a plurality, of the BAC clones of FIG. 2, and wherein the probes specifically hybridize to at least 1, at least 2, at least 3, at least 4, at least 5, at least 6 or at least 7 of the genomic loci set forth in FIG. 1B. In some embodiments, BRCA2 arrays capable of detecting BRCA2-like genomic copy number variations comprise a plurality of probes, wherein the nucleic acid sequences of the probes are unique to the genomic loci set forth in FIG. 1B. In some embodiments, BRCA2 arrays capable of detecting BRCA2-like genomic copy number variations comprise a plurality of probes, wherein the probes comprise a plurality of BAC clones specific to all of the genomic loci set forth in FIG. 1B. In some embodiments, BRCA2 arrays capable of detecting BRCA2-like genomic copy number variations comprise at least one, or a plurality, of probes, wherein the probes comprise greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, or greater than 700 of the distinct BAC clones of FIG. 2. In some embodiments, BRCA2 arrays capable of detecting BRCA2-like genomic copy number variations comprise at least three probes, wherein the probes comprise greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, or greater than 700 distinct BAC clones of FIG. 2 that specifically hybridize to at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24 or at least 25 of the genomic loci set forth in FIG. 1A. In some embodiments, BRCA2 arrays capable of detecting BRCA2-like genomic copy number variations comprise at least one, or a plurality, of probes, wherein the probes comprise greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, or greater than 700 distinct BAC clones of FIG. 2 that specifically hybridize to at least 1, at least 2, at least 3, at least 4, at least 5, at least 6 or at least 7 of the genomic loci set forth in FIG. 1B.

In various embodiments, BRCA2 arrays capable of detecting BRCA2-like genomic copy number variations that comprise at least one, or a plurality, of probes, and/or that comprise at least one, or a plurality, of distinct BAC clones, allow for the individual analysis of at least one, or a plurality, of distinct genomic loci. Therefore, in some embodiments, the probes, and/or the distinct BAC clones, capable of detecting BRCA2-like genomic copy number variations are arranged on the BRCA2 arrays in a positionally-addressable manner.

In various embodiments, BRCA2 arrays capable of detecting BRCA2-like genomic copy number variations comprise at least one, or a plurality, of distinct BAC clones, wherein the distinct BAC clones represent at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24 or at least 25 of the genomic loci set forth in FIG. 1A. In various embodiments, BRCA2 arrays capable of detecting BRCA2-like genomic copy number variations comprise at least one, or a plurality, of distinct BAC clones, wherein the distinct BAC clones represent at least 1, at least 2, at least 3, at least 4, at least 5, at least 6 or at least 7 of the genomic loci set forth in FIG. 1B. In various embodiments, BRCA2 arrays capable of detecting BRCA2-like genomic copy number variations comprise at least one, or a plurality, of distinct BAC clones, wherein the distinct BAC clones represent all 25 of the genomic loci set forth in FIG. 1A. In various embodiments, BRCA2 arrays capable of detecting BRCA2-like genomic copy number variations comprise at least one, or a plurality, of distinct BAC clones, wherein the distinct BAC clones represent all 7 of the genomic loci set forth in FIG. 1B.

### Array Comparative Genomic Hybridization

In various aspects, the present disclosure relates to the analysis of tumor cell samples by array-based comparative genomic hybridization. Array comparative genomic hybridization (aCGH) is a technique that is used to detect genomic copy number variations at a higher level of resolution than chromosome-based comparative genomic hybridization. In aCGH, nucleic acids from a test sample and nucleic acids from a reference sample are labelled differentially. The test sample and the reference sample are then hybridized to an array comprising a plurality of probes. The ratio of the signal intensity of the test sample to that of the reference sample is then calculated, to measure the copy number changes for a particular location in the genome. The difference in the signal ratio determines whether the total copy numbers of the nucleic acids in the test sample are increased or decreased as compared to the reference sample. The test sample and the reference sample may be hybridized to the array separately or they may be mixed together and hybridized simultaneously. Exemplary methods of performing aCGH can be found, for example, in U.S. Pat. Nos. 5,635,351; 5,665,549; 5,721,098; 5,830,645; 5,856,097; 5,965,362; 5,976,790; 6,159,685; 6,197,501; and 6,335,167; European Patent Nos. EP 1 134 293 and EP 1 026 260; van Beers et al., Brit. J. Cancer (2006), 20; Joosse et al., BMC Cancer (2007), 7:43; Pinkel et al., Nat. Genet. (1998), 20: 207-211; Pollack et al., Nat. Genet. (1999), 23: 41-46; and Cooper, Breast Cancer Res. (2001), 3: 158-175.

Samples that are labelled differentially are labelled such that one of the two samples is labelled with a first detectable agent and the other of the two samples is labelled with a second detectable agent, wherein the first detectable agent and the second detectable agent produce distinguishable signals. Detectable agents that produce distinguishable signals can include, for example, matched pairs of fluorescent dyes.

In some embodiments, the methods of the present disclosure comprise analyzing at least one test sample of tumor DNA from a subject by array-based comparative genomic hybridization to obtain information relating to the copy number aberrations present in the sample(s), if any; and based on the information obtained, classifying the tumor as a BRCA2-like tumor, a BRCAlikeness tumor or a non-BRCA2-like tumor.

Information relating to the copy number aberrations present in a sample can include, for example, a gain of genetic material at one or more genomic loci, a loss of genetic material at one or more genomic loci, chromosomal abnormalities at one or more genomic loci, and genome copy number changes at one or more genomic loci. This information is obtained by analyzing the difference in signal intensity between the test sample and a reference sample at one or more genomic loci. The analysis can be performed using any of a variety of methods, means and variations thereof for carrying out array-based comparative genomic hybridization.

In various embodiments, the reference sample is a nucleic acid sample that is representative of a normal, non-diseased state, for example a non-tumor/non-cancer cell, and contains a normal amount of copy numbers of the complement of the genomic loci being tested. The reference sample may be derived from a genomic nucleic acid sample from a normal and/or healthy individual or from a pool of such individuals. In various embodiments, the reference sample does not comprise any tumor or cancerous nucleic acids. In some embodiments, the reference sample is derived from a pool of female subjects. In some embodiments, the reference sample comprises pooled genomic DNA isolated from tissue samples (e.g. lymphocytes) from a plurality (e.g. at least 4-10) of healthy female subjects. In some embodiments, the reference sample comprises an artificially-generated population of nucleic acids designed to approximate the copy number level from each tested genomic region, or fragments of each tested genomic region. In some embodiments, the reference sample is derived from normal, non-cancerous cell lines or from cell line samples.

Test samples may be obtained from a biological source comprising tumor cells, and reference samples may be obtained from a biological source comprising normal reference cells, by any suitable method of nucleic acid isolation and/or extraction. In various aspects, the test sample and the reference sample are DNA. Methods of DNA extraction are well known in the art. A classical DNA isolation protocol is based on extraction using organic solvents, such as a mixture of phenol and chloroform, followed by precipitation with ethanol (see, e.g., Sambrook et al., supra). Other methods include salting out DNA extraction, trimethylammonium bromide salt extraction, and guanidinium thiocyanate extraction. Additionally, there are numerous DNA extraction kits that are commercially available from, for example, BD Biosciences Clontech (Palo Alto, Calif.), Epicentre Technologies (Madison, Wis.), Gentra Systems, Inc. (Minneapolis, Minn.), MicroProbe Corp. (Bothell, Wash.), Organon Teknika (Durham, N.C.), and Qiagen Inc. (Valencia, Calif.).

The test samples and the reference samples may be differentially labelled with any detectable agents or moieties. In various embodiments, the detectable agents or moieties are selected such that they generate signals that can be readily measured and such that the intensity of the signals is proportional to the amount of labelled nucleic acids present in the sample. In various embodiments, the detectable agents or moieties are selected such that they generate localized signals, thereby allowing resolution of the signals from each spot on an array.

Methods for labeling nucleic acids are well-known in the art. For exemplary reviews of labeling protocols, label detection techniques and recent developments in the field, see: Kricka, Ann. Clin. Biochem. (2002), 39: 114-129; van Gijlswijk et al., Expert Rev. Mol. Diagn. (2001), 1:81-91; and Joos et al., J. Biotechnol. (1994), 35: 135-153. Standard nucleic acid labeling methods include: incorporation of radioactive agents, direct attachment of fluorescent dyes or of enzymes, chemical modification of nucleic acids to make them detectable immunochemically or by other affinity reactions, and enzyme-mediated labeling methods including, without limitation, random priming, nick translation, PCR and tailing with terminal transferase. Other suitable labeling methods include psoralen-biotin, photoreactive azido derivatives, and DNA alkylating agents. In various embodiments, test sample and reference sample nucleic acids are labelled by Universal Linkage System, which is based on the reaction of monoreactive cisplatin derivatives with the N7 position of guanine moieties in DNA (see, e.g., Heetebrij et al., Cytogenet. Cell. Genet. (1999), 87: 47-52).

Any of a wide variety of detectable agents or moieties can be used to label test and/or reference samples. Suitable detectable agents or moieties include, but are not limited to: various ligands; radionuclides such as, for example, ³²P, ³⁵S, 3H, ¹⁴C, ¹²⁵I, ¹³¹I, and others; fluorescent dyes; chemiluminescent agents such as, for example, acridinium esters, stabilized dioxetanes, and others; microparticles such as, for example, quantum dots, nanocrystals, phosphors and others; enzymes such as, for example, those used in an ELISA, horseradish peroxidase, beta-galactosidase, luciferase, alkaline phosphatase and others; colorimetric labels such as, for example, dyes, colloidal gold and others; magnetic labels such as, for example, Dynabeads™; and biotin, dioxigenin or other haptens and proteins for which antisera or monoclonal antibodies are available.

In some embodiments, the test samples and the reference samples are labelled with fluorescent dyes. Suitable fluorescent dyes include, without limitation, Cy-3, Cy-5, Texas red, FITC, Spectrum Red, Spectrum Green, phycoerythrin, rhodamine, and fluorescein, as well as equivalents, analogues and/or derivatives thereof. In some embodiments, the fluorescent dyes selected display a high molar absorption coefficient, high fluorescence quantum yield, and photo stability. In some embodiments, the fluorescent dyes exhibit absorption and emission wavelengths in the visible spectrum (i.e., between 400 nm and 750 nm) rather than in the ultraviolet range of the spectrum (i.e., lower than 400 nm). In some embodiments, the fluorescent dyes are Cy-3 (3-N,N′-diethyltetramethylindo-dicarbocyanine) and Cy-5 (5-N,N′-diethyltetramethylindo-dicarbocyanine). Cy-3 and Cy-5 form a matched pair of fluorescent labels that are compatible with most fluorescence detection systems for array-based instruments. In some embodiments, the fluorescent dyes are Spectrum Red and Spectrum Green.

A key component of aCGH is the hybridization of a test sample and a reference sample to an array. Exemplary hybridization and wash protocols are described, for example, in Sambrook et al. (2001), supra; Tijssen (1993), supra; and Anderson (Ed.), “Nucleic Acid Hybridization” (1999), Springer Verlag: New York, N.Y. In some embodiments, the hybridization protocols used for aCGH are those of Pinkel et al., Nature Genetics (1998), 20:207-211. In some embodiments, the hybridization protocols used for aCGH are those of Kallioniemi, Proc. Natl. Acad. Sci. USA (1992), 89:5321-5325.

Methods of optimizing hybridization conditions are well known in the art (see, e.g., Tijssen, (1993), supra). To create competitive hybridization conditions, the array may be contacted simultaneously with differentially labelled nucleic acid fragments of the test sample and the reference sample. This may be done by, for example, mixing the labelled test sample and the labelled reference sample together to form a hybridization mixture, and contacting the array with the mixture.

The specificity of hybridization may be enhanced by inhibiting repetitive sequences. In some embodiments, repetitive sequences (e.g., Alu sequences, L1 sequences, satellite sequences, MRE sequences, simple homo-nucleotide tracts, and/or simple oligonucleotide tracts) present in the nucleic acids of the test sample, reference sample and/or probes are either removed, or their hybridization capacity is disabled. Removing repetitive sequences or disabling their hybridization capacity can be accomplished using any of a variety of well-known methods. These methods include, but are not limited to, removing repetitive sequences by hybridization to specific nucleic acid sequences immobilized to a solid support (see, e.g., Brison et al., Mol. Cell. Biol. (1982), 2: 578-587); suppressing the production of repetitive sequences by PCR amplification using adequately designed PCR primers; inhibiting the hybridization capacity of highly repeated sequences by self-reassociation (see, e.g., Britten et al., Methods of Enzymology (1974), 29: 363-418); or removing repetitive sequences using hydroxyapatite which is commercially available from a number of sources including, for example, Bio-Rad Laboratories, Richmond, Va. In some embodiments, the hybridization capacity of highly repeated sequences in a test sample and/or in a reference sample is competitively inhibited by including, in the hybridization mixture, unlabelled blocking nucleic acids. The unlabelled blocking nucleic acids are therefore mixed with the hybridization mixture, and thus with a test sample and a reference sample, before the mixture is contacted with an array. The unlabelled blocking nucleic acids act as a competitor for the highly repeated sequences and bind to them before the hybridization mixture is contacted with an array. Therefore, the unlabelled blocking nucleic acids prevent labelled repetitive sequences from binding to any highly repetitive sequences of the nucleic acid probes, thus decreasing the amount of background signal present in a given hybridization. In some embodiments, the unlabelled blocking nucleic acids are Human Cot-1 DNA. Human Cot-1 DNA is commercially available from a number of sources including, for example, Gibco/BRL Life Technologies (Gaithersburg, Md.).

Once hybridization is complete, the ratio of the signal intensity of the test sample as compared to the signal intensity of the reference sample is calculated. This calculation quantifies the amount of copy number aberrations present in the genomic DNA of the test sample, if any. In some embodiments, this calculation is carried out quantitatively or semi-quantitatively. In several aspects, it is not necessary to determine the exact copy number aberrations present in the genomic loci tested, as detection of an aberration, i.e. a gain or loss of genetic material, from the copy number in normal, non-cancerous genomic DNA is indicative of the presence of a disease state and is thus sufficient. Therefore, in several embodiments the quantification of the amount of copy number aberrations present in the genomic DNA of a test sample comprises an estimation of the copy number aberrations, as a semi-quantitative or relative measure usually suffices to predict the presence of a disease state and thus prospectively direct the determination of therapy for a subject.

Quantitative techniques may be used to determine the copy number aberrations per cell present in a test sample. Several quantitative and semi-quantitative techniques to determine copy number aberrations exist including, for example, semi-quantitative PCR analysis or quantitative real-time PCR. The Polymerase Chain Reaction (PCR) per se is not a quantitative technique, however PCR-based methods have been developed that are quantitative or semi-quantitative in that they give a reasonable estimate of original copy numbers, within certain limits. Examples of such PCR techniques include, for example, quantitative PCR and quantitative real-time PCR (also known as RT-PCR, RQ-PCR, QRT-PCR or RTQ-PCR). In addition, many techniques exist that give estimates of relative copy numbers, as calculated relative to a reference. Such techniques include many array-based techniques. Absolute copy number estimates may be obtained by in situ hybridization techniques such as, for example, fluorescence in situ hybridization or chromogenic in situ hybridization.

Fluorescence in situ hybridization permits the analysis of copy numbers of individual genomic locations and can be used to study copy numbers of individual genetic loci or particular regions on a chromosome (see, e.g., Pinkel et al., Proc. Natl. Acad. Sci. U.S.A. (1988), 85, 9138-42). Comparative genomic hybridization can also be used to probe for copy number changes of chromosomal regions (see, e.g., Kallioniemi et al., Science (1992), 258: 818-21; and Houldsworth et al., Am. J. Pathol. (1994), 145: 1253-60).

Copy numbers of genomic locations may also be determined using quantitative PCR techniques such as real-time PCR (see, e.g., Suzuki et al., Cancer Res. (2000), 60:5405-9). For example, quantitative microsatellite analysis can be performed for rapid measurement of relative DNA sequence copy numbers. In quantitative microsatellite analysis, the copy numbers of a test sample relative to a reference sample is assessed using quantitative, real-time PCR amplification of loci carrying simple sequence repeats. Simple sequence repeats are used because of the large numbers that have been precisely mapped in numerous organisms. Exemplary protocols for quantitative PCR are provided in Innis et al., PCR Protocols, A Guide to Methods and Applications (1990), Academic Press, Inc. N.Y. Semi-quantitative techniques that may be used to determine specific DNA copy numbers include, for example, multiplex ligation-dependent probe amplification (see, e.g., Schouten et al. Nucleic Acids Res. (2002), 30(12):e57; and Sellner et al., Human Mutation (2004), 23(5):413-419) and multiplex amplification and probe hybridization (see, e.g., Sellner et al. (2004), supra).

### BRCA2 Array Comparative Genomic Hybridization

In various aspects, the present disclosure relates to the use of a BRCA2 aCGH classifier capable of identifying BRCA2-like tumors in predicting whether an individual will benefit from anti-cancer therapy. In various aspects, a BRCA2 aCGH classifier capable of identifying BRCA2-like tumors is set forth on a BRCA2 array, as described herein.

Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci selected from 4p13-12, 13q12.2-21.1, 13q31.3-33.1, 14q23.2-32.33, 16q12.1-21, 17q11.1-12 and 17q21.2-21.31. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci selected from 6p25.3-11.1, 6q12-13 and 13q31.3-33.1. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci selected from 10q22.3-26.13, 13q12.2-21.1 and 14q23.2-32.33. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in the genomic locus 16p12.3-11.2. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci selected from 2q36.3-37.1, 4p13-12, 16q12.1-21, 17q11.1-12 and 17q21.2-21.31. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci set forth in FIG. 1A. Using the methods described above, in various aspects, a BRCA2 aCGH classifier, which in some embodiments is present in an array as described herein, is capable of detecting genomic copy number variations in a test sample, as compared to a reference sample, wherein the copy number variations are detected in at least one, or a plurality, of the genomic loci set forth in FIG. 1B. In some embodiments, a BRCA2 aCGH classifier, which in some embodiments is present in an array as described herein, is capable of detecting genomic copy number variations at a number of the above-listed genomic loci selected from greater than 1, greater than 2, greater than 3, greater than 4, greater than 5, greater than 6, greater than 7, greater than 8, greater than 9, greater than 10, greater than 11, greater than 12, greater than 13, greater than 14, greater than 15, greater than 16, greater than 17, greater than 18, greater than 19, greater than 20, greater than 21, greater than 22, greater than 23, and greater than 24. In some embodiments, a BRCA2 aCGH classifier, which in some embodiments is present in an array as described herein, is capable of detecting genomic copy number variations at a number of the above-listed genomic loci selected from less than 25, less than 24, less than 23, less than 22, less than 21, less than 20, less than 19, less than 18, less than 17, less than 16, less than 15, less than 14, less than 13, less than 12, less than 11, less than 10, less than 9, less than 8, less than 7, less than 6, less than 5, less than 4, less than 3, and less than 2.

Using the methods described above, in various aspects, a BRCA2 aCGH classifier, which in some embodiments is present in an array as described herein, is capable of detecting genomic copy number variations in a test sample using at least one, or a plurality, of probes that independently hybridize to at least one, or a plurality, of the genomic loci set forth in FIG. 1A. Using the methods described above, in various aspects, a BRCA2 aCGH classifier, which in some embodiments is present in an array as described herein, is capable of detecting genomic copy number variations in a test sample using at least one, or a plurality, of probes that independently hybridize to at least one, or a plurality, of the genomic loci set forth in FIG. 1B. Using the methods described above, in various aspects, a BRCA2 aCGH classifier, which in some embodiments is present in an array as described herein, is capable of detecting genomic copy number variations in a test sample, as compared to a reference sample, using at least one, or a plurality, of the distinct BAC clones set forth in FIG. 2. In some embodiments, a BRCA2 aCGH classifier, which in some embodiments is present in an array as described herein, capable of detecting genomic copy number variations in a test sample comprises all 704 of the BAC clones set forth in FIG. 2. In some embodiments, a BRCA2 aCGH classifier, which in some embodiments is present in an array as described herein, capable of detecting genomic copy number variations in a test sample comprises a number of the BAC clones set forth in FIG. 2 selected from greater than 1, greater than 10, greater than 20, greater than 25, greater than 50, greater than 75, greater than 100, greater than 125, greater than 150, greater than 175, greater than 200, greater than 225, greater than 250, greater than 275, greater than 300, greater than 325, greater than 350, greater than 375, greater than 400, greater than 425, greater than 450, greater than 475, greater than 500, greater than 525, greater than 550, greater than 575, greater than 600, greater than 625, greater than 650, greater than 675, and greater than 700. In some embodiments, a BRCA2 aCGH classifier, which in some embodiments is present in an array as described herein, capable of detecting genomic copy number variations in a test sample comprises a number of the BAC clones set forth in FIG. 2 selected from less than 704, less than 700, less than 675, less than 650, less than 625, less than 600, less than 575, less than 550, less than 525, less than 500, less than 475, less than 450, less than 425, less than 400, less than 375, less than 350, less than 325, less than 300, less than 275, less than 250, less than 225, less than 200, less than 175, less than 150, less than 125, less than 100, less than 75, less than 50, less than 25, less than 20, and less than 10.

### Therapeutic Uses

In various aspects, the BRCA2 classifiers, which in some embodiments are present in one or more arrays as described herein, can be used to predict whether an individual will benefit from anti-cancer therapy.

Using the methods described above, in various aspects, the BRCA2 classifiers are capable of determining whether an individual metastatic breast cancer patient, in continuous complete remission after one or more anti-cancer therapies, has a BRCA2-like tumor. Using the methods described above, in various aspects, the BRCA2 classifiers are capable of determining whether a metastatic breast cancer patient with a BRCA2-like tumor has a significantly higher complete remission rate. The BRCA2 classifiers are therefore capable of predicting whether an individual patient will benefit from anti-cancer therapy. Using the methods described above, in various aspects, the BRCA2 classifiers are capable of predicting improved outcome after anti-cancer therapy by identifying breast cancer patients specifically benefiting from one or more anti-cancer therapies.

The BRCA2 classifiers can be used as pre-selection tools, to prospectively detect subjects with a high risk of carrying a BRCA2-mutation and/or a BRCA2-like tumor. Additionally, the BRCA2 classifiers can be used as predictive tests to identify breast cancer patients likely to benefit from anti-cancer therapy.

In further aspects, the present disclosure relates to kits for use in the diagnostic applications described above. The kits can comprise any or all of the reagents to perform the methods described herein. The kits can comprise one or more of the BRCA2 classifiers, which in some embodiments are present in one or more arrays as described herein. In the diagnostic applications such kits may include any or all of the following: assay reagents, buffers, nucleic acids such as hybridization probes and/or primers that specifically bind to at least one of the genomic locations described herein, as well as arrays comprising such nucleic acids. In addition, the kits may include instructional materials containing directions (i.e., protocols) for the practice of the methods of this disclosure. While the instructional materials typically comprise written or printed materials they are not limited to such. Any medium capable of storing such instructions and communicating them to an end user is contemplated by this disclosure. Such media include, but are not limited to electronic storage media (e.g., magnetic discs, tapes, cartridges, chips), optical media (e.g., CD ROM), and the like. Such media may include addresses to internet sites that provide such instructional materials.

### EXAMPLES

The following examples describe in detail certain embodiments of the BRCA2 arrays and the BRCA2 aCGH classifiers. It will be apparent to those skilled in the art that many modifications, both to materials and methods, may be practiced without departing from the scope of the disclosure.

### Example 1

### Homologous Recombination Deficiency in Breast Cancer and Association with Response to Neo-Adjuvant Chemotherapy

Tumors with homologous recombination deficiency (HRD), such as BRCA2 associated breast cancers, are not able to reliably repair DNA double strand breaks (DSBs), and are highly sensitive to alkylating agents and PARP inhibitors. In this Example, markers that may indicate the presence of HRD in patients with HER2-negative breast cancer, scheduled to receive neoadjuvant chemotherapy, were studied. Forty-three triple negative (TN) and 91 estrogen receptor positive (ER+) pre-treatment biopsies from sporadic breast cancer patients were examined. In ER+ tumors, an aCGH “BRCA2-like” pattern and the amplification of the BRCA2 inhibiting gene EMSY were frequently observed (37% and 15% respectively). A “BRCA2-like” aCGH pattern was associated with a significantly higher response rate to neoadjuvant chemotherapy with doxorubicin and cyclophosphamide. In addition, EMSY amplification and a “BRCA2-like” pattern rarely occurred together, raising doubts about the assumption that EMSY amplification inactivates BRCA2 and causes HRD. In conclusion, in ER+/HER2-tumors, a ‘BRCA2-like’ aCGH profile may be predictive of chemotherapy response.

Introduction

The breast cancer genes BRCA1 and BRCA2 are involved in homologous recombination and tumors of patients carrying germ-line mutations in these genes, show HRD. BRCA1 and BRCA2 can be inactivated in sporadic cancers as well (Joosse, S. A., van Beers, E. H., Tielen, I. H., et al Prediction of BRCA1-association in hereditary non-BRCA1/2 breast carcinomas with array-CGH, Breast Cancer Res Treat, 2008; and Turner, N., Tutt, A. and Ashworth, A. Hallmarks of ‘BRCAness’ in sporadic cancers, Nat Rev Cancer, 4: 814-819, 2004), a phenomenon sometimes referred to as “BRCA-likeness” (or “BRCAness”). Many other genes are involved in homologous recombination, including the Fanconi anemia genes and the BRCA2 inactivating gene EMSY (Hughes-Davies, L., Huntsman, D., Ruas, M., et al EMSY links the BRCA2 pathway to sporadic breast and ovarian cancer, Cell, 115: 523-535, 2003).

It has been previously shown that breast cancers of BRCA1 mutation carriers have a characteristic pattern of DNA gains and losses in an array comparative genomic hybridization (aCGH) assay (Wessels, L. F., van Welsem, T., Hart, A. A., Van't Veer, L. J., Reinders, M. J. and Nederlof, P. M. Molecular classification of breast carcinomas by comparative genomic hybridization: a specific somatic genetic profile for BRCA1 tumors, Cancer Res, 62: 7110-7117, 2002). This pattern is also found in a subgroup of HER-2 negative sporadic breast cancers that do not contain a BRCA1 mutation. The BRCA1-like pattern accurately identified tumors benefiting from intensive alkylating chemotherapy in two recent retrospective studies (Vollebergh, M. A., Lips E. H., Nederlof, P. M., et al. An aCGH classifier derived from BRCA1-mutated breast cancer and benefit of high-dose platinum-based chemotherapy in HER2-negative breast cancer patients, Ann Oncol, 2010, in press). An aCGH classifier that recognizes breast cancers of BRCA2 mutation carriers has been found as well (Joosse, S. A., Brandwijk, K. I. M., Devilee, P., et al Prediction of BRCA2-association in hereditary breast carcinomas with array-CGH, Breast Cancer Res Treat. 2010 Jul. 8. PubMed PMID: 20614180). Each of the above mentioned tests could be useful to detect HRD in clinical samples.

In this Example, the frequency in which these possibly HRD-associated features occur in untreated patients with breast cancer was prospectively determined. The findings were correlated with beneficial response to chemotherapy that causes DNA DSBs. If HRD is confirmed to be the “Achilles heel” of certain sporadic tumors, such tests could eventually serve to individualize drug treatment.

Patients and Methods

Patients

Pre-treatment biopsies of primary breast tumors from 134 women with HER2 negative breast cancer were collected. All patients had received neoadjuvant treatment at the Netherlands Cancer Institute between 2000 and 2007 as part of two ongoing clinical trials, or were treated off protocol according to the standard arm of one of these studies. Both studies had been approved by the ethical committee and written informed consent was obtained. For eligibility, breast carcinoma with either a primary tumor size of at least 3 cm was required, or the presence of fine needle aspiration (FNA)-proven axillary lymph node metastases. Biopsies were taken using a 14G core needle under ultrasound guidance. After collection, specimens were snap-frozen in liquid nitrogen and stored at −70° C. Each patient had two or three biopsies taken to assure that enough tumor material was available for both diagnosis and further study.

Depending on the particular study, a treatment regimen was assigned to each patient, which consisted of one of the following: 1.) Six courses of dose-dense Doxorubicin/Cyclophosphamide (ddAC) or 2.) Six courses of Capecitabine/Docetaxel (CD) or 3.) Three courses of ddAC followed by three courses CD (or vice versa) if the therapy response was considered unfavorable by MRI evaluation after three courses. For the response analysis, only patients who started with ddAC (group 1 and group 3) were considered.

Response Evaluation

The response of the primary tumor to chemotherapy was evaluated by contrast-enhanced MRI (Loo, C. E., Teertstra, H. J., Rodenhuis, S., et al Dynamic contrast-enhanced MRI for prediction of breast cancer response to neoadjuvant chemotherapy: initial results, AJR Am J Roentgenol, 191: 1331-1338, 2008) after 3 courses of chemotherapy, and after surgery by pathologic evaluation of the resection specimen. The primary end point of both studies was a pCR, defined as the complete absence of residual invasive tumor cells seen at microscopy. If only non-invasive tumor (carcinoma in situ) was detected, this was considered a pCR as well. When a small number of scattered tumor cells were seen, the samples were classified as ‘near pCR’ (npCR). Because the aim of this study was to determine if HRD was correlated with a higher sensitivity to chemotherapy, tumors with a npCR were included in the group of complete remission for analytical purposes. Patients with larger amounts of residual tumor left were classified as non-responders (NR).

Array-CGH

Tumor DNA and reference DNA were co-hybridized using two different CyDyes to a microarray containing 3.5 k BAC/PAC derived DNA segments covering the whole genome with an average spacing of 1 MB and processed as described before (Joosse, S. A., van Beers, E. H. and Nederlof, P. M. Automated array-CGH optimized for archival formalin-fixed, paraffin-embedded tumor material, BMC Cancer, 7: 43, 2007). Classification of subtypes was performed using the aCGH BRCA2 classifiers disclosed herein (FIG. 2) and developed by Joosse et al. (Joosse, S. A., van Beers, E. H., Tielen, I. H., et al Prediction of BRCA1-association in hereditary non-BRCA1/2 breast carcinomas with array-CGH, Breast Cancer Res Treat, 2008; and Joosse, S. A., Brandwijk, K. I. M., Devilee, P., et al Prediction of BRCA2-association in hereditary breast carcinomas using array-CGH, Breast Cancer Res Treat. 2010 Jul. 8. PubMed PMID: 20614180). When the BRCA2 score was 0.50 or higher the tumour was qualified as BRCA2-like (Joosse, S. A., Brandwijk, K. I. M., Devilee, P., et al Prediction of BRCA2-association in hereditary breast carcinomas using array-CGH, Breast Cancer Res Treat. 2010 Jul. 8. PubMed PMID: 20614180). Under this cut-off a tumour was called non-BRCA2-like.

MLPA

Amplification of EMSY (C11orf30) was determined using a custom MLPA set, containing seven different EMSY probes and nine reference probes (MRC Holland, The Netherlands; X025). This EMSY MLPA set was first validated by an EMSY FISH assay (Dako, Glostrup, Denmark). From the comparison of the EMSY FISH assay and the MLPA, it was concluded that an average of the seven probes above 1.5 corresponded to EMSY amplification, as detected by at least 6 copies of the probe at the FISH assay. DNA fragments were analyzed on a 3730 DNA Analyzer (AB, USA). For normalization and analysis the Coffalizer program was used (MRC-Holland, The Netherlands).

Statistical Tests

The Fisher's exact test was used to assess association between the dichotomized HRD characteristics and treatment response. The Mann-Whitney U test was used to analyze means of variables and relate it to treatment response. All data analyses were performed using SPSS version 15.

Results

Overview of Samples

In the series of patients described in this Example, the frequency of features associated with BRD in pre-treatment biopsies was studies, and possible relationships with beneficial response to chemotherapy known to cause DNA DSBs were explored. HER2+ tumors were not investigated in this study, because they were treated with regimens based on trastuzumab and taxanes, agents that do not cause DNA DSBs. The choice for EMSY amplification was pragmatic, since this test can be performed reliably on small pretreatment biopsies. aCGH was used to assess “BRCA-ness”. If the pattern of genomic alterations resembled those in BRCA2 associated tumors, the sample was called BRCA2-like. If no pattern was recognized the tumor was called non-BRCA2-like. A total of 134 tumors were studied, of which 91 were ER+ and 43 were Triple Negative tumors. See table 1 for an overview of the different patients.

TABLE 1
Patient and tumor characteristics

| | | TN | | ER+ | |
|---|---|---|---|---|---|
| Number of patients | | 43 | | 91 | |
| Median age (sd) | | 45 (11.18) | | 50.5 (9.14) | |
| Progesterone receptor | Positive | 0 | 0% | 58 | 64% |
| | Negative | 100 | 100% | 33 | 36% |
| T-stage | T1 | 2 | 5% | 12 | 13% |
| | T2 | 29 | 67% | 51 | 56% |
| | T3 | 11 | 26% | 25 | 28% |
| | T4 | 1 | 2% | 3 | 3% |
| N-stage | Node negative | 28 | 65% | 22 | 24% |
| | Node positive | 15 | 35% | 69 | 76% |
| Initial chemotherapy | AC | 38 | 88% | 81 | 89% |
| | DC | 2 | 5% | 7 | 8% |
| | other | 3 | 7% | 3 | 3% |
| Response | pCR | 15 | 34% | 6 | 7% |
| | npCR | 7 | 16% | 12 | 13% |
| | NR | 19 | 44% | 67 | 74% |
| | unknown | 2 | 5% | 6 | 7% |

AC = doxorubicin, cyclophosphamide; DC = docetaxel, capecitabine; (n)pCR = (near) pathological complete remission; NR = non response.

Array comparative genomic hybridization was performed in 37 TN and 75 ER+ tumors. A BRCA2-like profile was observed in both TN and ER+ tumors (32% and 37% respectively) (Table 2). The BRCA2 inhibiting gene EMSY was only amplified in ER+ tumors, in this tumor group the frequency was 15%. This initial analysis shows that EMSY amplification is specific for ER+ tumors and a BRCA2-like profile occurs in both TN and ER+ tumors. This is in concordance with the fact that tumors in BRCA2 carriers are often ER+ (Chappuis, P. O., Nethercot, V. and Foulkes, W. D. Clinico-pathological characteristics of B, Semin Surg Oncol, 18: 287-295, 2000).

TABLE 2
Summary of HRD characteristics

| | TN (n = 43) | ER+ (n = 91) | p-value |
|---|---|---|---|
| aCGH BRCA2-like | | | |
| B2-like | 12 (32%) | 28 (37%) | |
| non-B2-like | 25 (66%) | 47 (63%) | 0.832 |
| EMSY Amplification | | | |
| Amplification | 0 (0%) | 9 (15%) | |
| No amplification | 23 (100%) | 51 (85%) | 0.057 |

ER+ Tumors and BRCA2-Like Profile and EMSY Amplification

Table 3 gives an overview of HRD characteristics in ER+ tumors. As mentioned earlier, many ER+ tumors show a BRCA2-like pattern or an amplification of the BRCA2 inactivating protein EMSY. Interestingly, a BRCA2-like pattern and EMSY amplification occur together in only one tumor sample (Table 3).

TABLE 3
Overview of HRD characteristics in ER+ tumors*

| Sample Number | BRCA2 like | EMSY amplification |
|---|---|---|
| 2055 | − | − |
| 2105 | − | − |
| 2099 | + | + |
| 2013 | + | |
| 2016 | + | |
| 2017 | + | |
| 2032 | + | |
| 2044 | + | |
| 2114 | + | |
| 2138 | + | |
| 2147 | + | |
| 100 | + | − |
| 158 | + | − |
| 2062 | + | − |
| 2065 | + | − |
| 2071 | + | − |
| 2073 | + | − |
| 2075 | + | − |
| 2077 | + | − |
| 2085 | + | − |
| 2098 | + | − |
| 2117 | + | − |
| 2122 | + | − |
| 2128 | + | − |
| 2143 | + | − |
| 2144 | + | − |
| 2151 | + | − |
| 2153 | + | − |
| 2081 | + | − |
| 2100 | + | − |
| 2086 | − | + |
| 2087 | − | + |
| 110 | − | + |
| 112 | − | + |
| 2038 | − | + |
| 2058 | − | + |
| 2084 | − | + |
| 2120 | − | + |
| 2023 | − | |

*Only samples with at least one characteristic are shown

Table 4 gives an overview of HRD characteristics related to clinical pathological factors. Investigation into whether BRCA2 and EMSY were related to PR positivity, T-stage, N-stage and response to neoadjuvant treatment was performed. For a BRCA2 pattern no association was observed for PR positivity, T-stage and N-stage. There was a significant association between BRCA2-like pattern and a higher response rate to alkylating neoadjuvant chemotherapy (35% vs. 12%, p=0.033). No differences in response to therapy between tumors with an EMSY amplification or without was observed.

TABLE 4
Association between BRCA2 pattern and EMSY amplification
and clinical pathological variables in ER + tumor samples.

| | BRCA2 like pattern | | | | | EMSY | | | | |
|---|---|---|---|---|---|---|---|---|---|---|
| | BRCA2-like | | Sporadic-like | | p-value | Amplification | | No amplification | | p-value |
| PRpos | 15/27 | (56%) | 36/47 | (77%) | 0.072 | 7/9 | (78) | 34/51 | (68) | 0.71 |
| T-stage | | | | | | | | | | |
| 1 | 2/28 | (7%) | 8/48 | (17%) | | 0 | (0%) | 8/51 | (16%) | |
| 2 | 18/28 | (64%) | 26/48 | (54%) | | 5/9 | (56%) | 28/51 | (55%) | |
| 3 | 7/28 | (25%) | 13/48 | (27%) | | 4/9 | (44%) | 14/51 | (28%) | |
| 4 | 1/28 | (4%) | 1/48 | (2%) | | 0 | | 1/51 | (2%) | |
| N-stage | | | | | | | | | | |
| Pos | 19/28 | (68%) | 41/48 | (83%) | 0.086 | 7/9 | (78%) | 41/51 | (80%) | 1 |
| Response on A/C* | | | | | | | | | | |
| pCR + npCR | 9/26 | (35%) | 5/42 | (12%) | 0.033 | 2/7 | (29%) | 8/46 | (18%) | 0.604 |

*Response was measured only on samples from patients treated with A/C

Discussion

Classical chemotherapeutic agents that cause DNA double-strand breaks (DSBs) are thought to be particularly effective in tumors with HRD (Kennedy, R. D., Quinn, J. E., Mullan, P. B., Johnston, P. G. and Harkin, D. P. The role of BRCA1 in the cellular response to chemotherapy, J Natl Cancer Inst, 96: 1659-1668, 2004; Fedier, A., Steiner, R. A., Schwarz, V. A., Lenherr, L., Haller, U. and Fink, D. The effect of loss of Brca1 on the sensitivity to anticancer agents in p53-deficient cells, Int J Oncol, 22: 1169-1173, 2003; Helleday, T., Petermann, E., Lundin, C., Hodgson, B. and Sharma, R. A. DNA repair pathways as targets for cancer therapy, Nat Rev Cancer, 8: 193-204, 2008; Moynahan, M. E., Cui, T. Y. and Jasin, M. Homology-directed dna repair, mitomycin-c resistance, and chromosome stability is restored with correction of a Brca1 mutation, Cancer Res, 61: 4842-4850, 2001; and Powell, S. N. and Kachnic, L. A. Therapeutic exploitation of tumor cell defects in homologous recombination, Anticancer Agents Med Chem, 8: 448-460, 2008) and the novel class of PARP inhibiting drugs has been shown to have marked antitumor activity with very little toxicity (Bryant, H. E., Schultz, N., Thomas, H. D., et al Specific killing of BRCA2-deficient tumours with inhibitors of poly(ADP-ribose)polymerase, Nature, 434: 913-917, 2005; and Farmer, H., McCabe, N., Lord, C. J., et al Targeting the DNA repair defect in BRCA mutant cells as a therapeutic strategy, Nature, 434: 917-921, 2005). Unfortunately, a demonstration of HRD in clinical tumor samples is problematic. One reported assay measures DSB repair pathways, but requires short-term cultures of primary breast cancer cells (Keimling, M., Kaur, J., Bagadi, S. A., Kreienberg, R., Wiesmuller, L. and Ralhan, R. A sensitive test for the detection of specific DSB repair defects in primary cells from breast cancer specimens, Int J Cancer, 123: 730-736, 2008). Immunohistochemical methods have been proposed as well, aiming to detect CHK1 and RAD51 localization in the cytoplasm and/or the nucleus (Honrado, E., Osorio, A., Palacios, J., et al Immunohistochemical expression of DNA repair proteins in familial breast cancer differentiate BRCA2-like tumors, J Clin Oncol, 23: 7503-7511, 2005), but reliable immunohistochemical staining results can be difficult to obtain. Others have used methylation assays for BRCA1 (Esteller, M., Silva, J. M., Dominguez, G., et al Promoter hypermethylation and BRCA1 inactivation in sporadic breast and ovarian tumors, J Natl Cancer Inst, 92: 564-569, 2000; and Catteau, A., Harris, W. H., Xu, C. F. and Solomon, E. Methylation of the BRCA1 promoter region in sporadic breast and ovarian cancer: correlation with disease characteristics, Oncogene, 18: 1957-1965, 1999), FancC and FancD and have studied EMSY amplification (Rodriguez, C., Hughes-Davies, L., Valles, H., et al Amplification of the BRCA2 pathway gene EMSY in sporadic breast cancer is related to negative outcome, Clin Cancer Res, 10: 5785-5791, 2004), for example by an in situ hybridization assay (Turner, N., Tutt, A. and Ashworth, A. Hallmarks of ‘BRCAness’ in sporadic cancers, Nat Rev Cancer, 4: 814-819, 2004). The sensitivity and specificity of these approaches is unknown and a possible association of these features with neoadjuvant treatment response has not been reported.

High-dose alkylating chemotherapy has previously been employed in the treatment of patients with breast cancer, with either a high risk of relapse (Rodenhuis, S., Bontenbal, M., Beex, L. V., et al High-dose chemotherapy with hematopoietic stem-cell rescue for high-risk breast cancer, N Engl J Med, 349: 7-16, 2003) or with distant metastases (Schrama, J. G., Baars, J. W., Holtkamp, M. J., Schornagel, J. H., Beijnen, J. H. and Rodenhuis, S. Phase II study of a multi-course high-dose chemotherapy regimen incorporating cyclophosphamide, thiotepa, and carboplatin in stage 1V breast cancer, Bone Marrow Transplant, 28: 173-180, 2001). In both studies, a modest survival advantage for patients who had received this intensive treatment was observed, a result which has also been documented in meta-analyses of the randomized studies (Berry, D. A., Ueno, N. T., Johnson, M. M., et al High-dose chemotherapy with autologous stem-cell support versus standard-dose chemotherapy: meta-analysis of individual patient data from 6 randomized metastatic breast cancer trials, Proc. San Antonio Breast Cancer Symp, Abstract 6113:2008). These observations are consistent with the existence of a putative subgroup of breast cancers that is highly responsive to alkylating drugs, as has been previously speculated based on clinical observations (Rodenhuis, S. The status of high-dose chemotherapy in breast cancer, Oncologist, 5: 369-375, 2000; and Rodenhuis, S. High-dose chemotherapy in breast cancer—interpretation of the randomized trials, Anticancer Drugs, 12: 85-88, 2001). This subgroup could overlap or even be identical with the subgroup of tumors that show HRD. To study this hypothesis, Vollebergh et al. have recently applied the aCGH test to search for the ‘BRCA1 like’ pattern (Joosse, S. A., van Beers, E. H., Tielen, I. H., et al Prediction of BRCA1-association in hereditary non-BRCA1/2 breast carcinomas with array-CGH, Breast Cancer Res Treat, 2008; Wessels, L. F., van Welsem, T., Hart, A. A., Van't Veer, L. J., Reinders, M. J. and Nederlof, P. M. Molecular classification of breast carcinomas by comparative genomic hybridization: a specific somatic genetic profile for BRCA1 tumors, Cancer Res, 62: 7110-7117, 2002; and van Beers, E. H., van Welsem, T., Wessels, L. F., et al Comparative genomic hybridization profiles in human BRCA1 and BRCA2 breast tumors highlight differential sets of genomic aberrations, Cancer Res, 65: 822-827, 2005) in metastatic tumors and related it to the treatment results of intensive alkylating chemotherapy (Vollebergh, M. A., Lips E. H., Nederlof, P. M., et al. An aCGH classifier derived from BRCA1-mutated breast cancer and benefit of high-dose platinum-based chemotherapy in HER2-negative breast cancer patients, Ann Oncol, 2010, in press). It was observed that all long-term survivors of stage 1V breast cancer had tumors with the BRCA1-like signature. It was shown in a second retrospective study, that triple-negative tumors with the BRCA1-signature benefited markedly from high-dose therapy in the adjuvant setting, while the triple-negative tumors with a non-BRCA1-like like profile did not (Vollebergh, M. A., Lips E. H., Nederlof, P. M., et al. An aCGH classifier derived from BRCA1-mutated breast cancer and benefit of high-dose platinum-based chemotherapy in HER2-negative breast cancer patients, Ann Oncol, 2010, in press). The recent aCGH test to detect a pattern of DNA gains and losses associated with breast cancers in BRCA2 carriers (Joosse, S. A., Brandwijk, K. I. M., Devilee, P., et al Prediction of BRCA1- and BRCA2-association in hereditary breast carcinomas with array-CGH, Submitted for publication, 2009) has not yet been studied in relation to chemotherapy response.

In the series of patients described herein, the frequency of certain features associated with HRD in untreated breast cancers was studied and possible relationships with neoadjuvant treatment response were explored. HER2+ tumors were not investigated in this study, because they are treated with different agents, such as trastuzumab and taxanes, which do not cause DSBs. BRCA2 inactivation, shown by a BRCA2 like aCGH profile and EMSY amplification, was specifically observed in ER+ tumors. A significantly higher response rate of ER+ tumors with the BRCA2 profile to DSBs-causing chemotherapy was observed.

Features of BRCA2 Inactivation

Of the ER+ and TN tumors combined, roughly one-third had a BRCA2-like profile, while EMSY amplification was exclusively found in the ER+ tumors. In a series of 183 breast tumors from BRCA2 mutation carriers and from sporadic breast tumors, BRCA2 methylation has been assessed, but methylation has not been found in any of the samples (Joosse, S. A., Brandwijk, K. I. M., Devilee, P., et al Prediction of BRCA2-association in hereditary breast carcinomas with array-CGH, Breast Cancer Res Treat. 2010 Jul. 8. PubMed PMID: 20614180). In the literature, BRCA2 promotor methylation has been sporadically observed in ovarian cancer (Hilton, J. L., Geisler, J. P., Rathe, J. A., Hattermann-Zogg, M. A., DeYoung, B. and Buller, R. E. Inactivation of BRCA1 and BRCA2 in ovarian cancer, J Natl Cancer Inst, 94: 1396-1406, 2002), but not in breast cancer. An alternative mechanism for BRCA2 inactivation involves amplification of the EMSY gene. Interestingly, the present study did not identify any overlap between tumors showing a BRCA2-like profile and EMSY amplification, except in one case (Table 3). This observation points at two different routes or levels of BRCA2 inactivation. In tumors with EMSY amplification, usually a lower degree of chromosomal gains and losses is observed than in the BRCA2-like tumors. This does not support the hypothesis that EMSY is a HRD characteristic and would consequently show a high level of genomic instability. Moreover, in a different series of 52 sporadic tumors from which aCGH data are available, 7 ER+ tumors have been detected with a gain at the EMSY locus, and none of these showed a BRCA2 like profile. This supports the finding that EMSY and the BRCA2 like profile only rarely occur together and that EMSY amplification is not associated with the same degree of chromosomal instability as BRCA2 mutation. In vitro assays have shown that the EMSY protein can bind BRCA2 protein and inactivate its function (Raouf, A., Brown, L., Vrcelj, N., et al Genomic instability of human mammary epithelial cells overexpressing a truncated form of EMSY, J Natl Cancer Inst, 97: 1302-1306, 2005). An increase in chromosomal instability was observed after EMSY overexpression.

ER+ tumors with a BRCA2-like profile show higher response rates to neoadjuvant chemotherapy with cyclophophamide and doxorubicin than ER+ tumors with a non-BRCA2-like profile. This is remarkable as ER+ tumors usually show a low pCR rate (5-10%) after neoadjuvant therapy. In the present study, ER+ tumors with a BRCA2-like profile had a (near)pCR rate of 35% versus 12% for ER+ tumors with a non-BRCA2-like profile. EMSY amplified tumors did not show a difference in response rates, which is in line with the finding that these tumors have a lower degree of chromosomal instability and thus are not HRD. If confirmed, these findings could have important implications for neoadjuvant chemotherapy selection in ER+ tumors.

Conclusion

A BRCA2 aCGH pattern appears to be a strong predictor of response in ER+HER2-tumors. EMSY amplification is not correlated with a BRCA2 like profile, indicating that it may not signify HRD.

### Example 2

The predictive value of one or more of the BRCA2-classifiers disclosed herein (see, for example, FIG. 2) was evaluated for selective benefit of high-dose (HD) alkylating chemotherapy, a DNA double strand break-inducing regimen, with autologous stem cell rescue in the subgroup of hormone receptor positive, HER2-negative patients who have participated in the RODENHUIS trial (Rodenhuis, S., Bontenbal, M., Beex, L. V., et al High-dose chemotherapy with hematopoietic stem-cell rescue for high-risk breast cancer, N Engl J Med, 349: 7-16, 2003).

Methods

To determine whether the BRCA2-classifiers disclosed herein predict benefit from HD-chemotherapy, a study comprising a random sample (N=249) taken from the HER2 negative subpopulation (N=621) who participated in a randomized controlled trial of standard adjuvant chemotherapy (5 courses of 5-fluorouracil, epirubicin, cyclophosphamide (FEC)) versus 4 courses of FEC followed by high dose cyclophosphamide, thiotepa and carboplatin (CTC) with autologous stem cell support was performed. BRCA2-probability scores were obtained for every sampled patient according to the methods disclosed herein. The cut-off of the BRCA2-probability score used in this study was as had been reported before (Joosse, S. A., Brandwijk, K. I. M., Devilee, P., et al Prediction of BRCA2-association in hereditary breast carcinomas using array-CGH, Breast Cancer Res Treat. 2010 Jul. 8. PubMed PMID: 20614180; Lips et al. Ann Oncol 2010 in press). To assess whether this cut-off of the reported BRCA2-classifier could also serve as a predictive marker for benefit of DNA DSB-inducing anticancer therapies, the interaction between the BRCA2-classifier and benefit of HD-chemotherapy (CTC) with autologous stem cell support was evaluated.

The trial described in this Example has previously received the approval of the Institutional Review board of the Netherlands Cancer Institute. This study has been designed following the REMARK guidelines.

Random Patient Sample (Stage-III Series)

Patients were randomly sampled from the HER2-negative subpopulation that had participated in a large, randomized, controlled, multicentre trial performed in the Netherlands between 1993 and 1999. Inclusion criteria have been published previously (Rodenhuis, S., Bontenbal, M., Beex, L. V., et al High-dose chemotherapy with hematopoietic stem-cell rescue for high-risk breast cancer, N Engl J Med, 349: 7-16, 2003). Eligible patients were randomized between either conventional chemotherapy (five courses FEC), or HD-chemotherapy, which is identical except that instead of the fifth course of FEC, a course of CTC was given. Based on prior experience, it is known that HER2-positive breast cancer patients did not derive any benefit of HD-PB-chemotherapy (Rodenhuis, S., Bontenbal, M., Beex, L. V., et al High-dose chemotherapy with hematopoietic stem-cell rescue for high-risk breast cancer, N Engl J Med, 349: 7-16, 2003). Therefore, patients with HER2-positive breast cancer have been omitted from this selection. In addition, these patients now typically receive highly effective trastuzumab-based adjuvant systemic therapy in the clinic.

Cases were only included when their FFPE primary tumor tissue was available and contained more than 60% of tumor cells.

Comparative Genomic Hybridization and Mutation Analyses

aCGH patterns of the BRCA1-like^{CGH} pattern of 230 patients that had been previously generated were used in this study (Vollebergh, M. A., Lips E. H., Nederlof, P. M., et al. An aCGH classifier derived from BRCA1-mutated breast cancer and benefit of high-dose platinum-based chemotherapy in HER2-negative breast cancer patients, Ann Oncol, 2010, in press). Tumours of 19 patients could additionally be analyzed in this series. In short, genomic DNA was extracted from FFPE primary tumours (van Beers E H, Joosse S A, Ligtenberg M J et al. A multiplex PCR predictor for aCGH success of FFPE samples. Br J Cancer 2006; 94(2):333-337). Of seven of these 19 patients, only lymph-node tissue containing primary tumour tissue, removed at first diagnosis, was available. Three of these 19 samples contained DNA concentrations that were too low for direct aCGH-analysis and these samples were amplified with the BioScore™ Screening and Amplification Kit (42440, Enzo Life Sciences). Tumor and reference DNA was labelled according to the manufacturers' instructions (Kreatech Biotechnology, Amsterdam) and used for aCGH as previously described (Joosse S A, van Beers E H, Nederlof P M. Automated Array-CGH Optimized for Archival Formalin-Fixed, Paraffin-Embedded Tumor Material. BMC Cancer 2007; 7: 43). Slides were scanned with an Agilent DNA Microarray Scanner BA on the same day. The quality of each aCGH pattern was determined using a profile-quality and hybridization quality score, as previously published (Vollebergh, M. A., Lips E. H., Nederlof, P. M., et al. An aCGH classifier derived from BRCA1-mutated breast cancer and benefit of high-dose platinum-based chemotherapy in HER2-negative breast cancer patients, Ann Oncol, 2010, in press). The data of 230 of the 249 patients have been deposited in NCBI's Gene Expression Omnibus, with the data of the remaining 19 patients to be added.

Histopathology

Two pathologists (JW and MvdV) had previously reviewed all tumors and scored whole Haematoxylin & Eosin (H&E)-slides for tumor percentages. Oestrogen-receptor (ER), progesterone-receptor (PR), P53, and HER2 status were determined by immunohistochemistry (IHC) as described previously (Rodenhuis S, Bontenbal M, Beex L V et al. High-Dose Chemotherapy With Hematopoietic Stem-Cell Rescue for High-Risk Breast Cancer. N Engl J Med 2003; 349 (1): 7-16; van de Vijver M J, Peterse J L, Mooi W J et al. Neu-Protein Overexpression in Breast Cancer. Association With Comedo-Type Ductal Carcinoma in Situ and Limited Prognostic Value in Stage 11 Breast Cancer. N Engl J Med 1988; 319 (19): 1239-1245).

Statistical Analysis

Groups of interest were tested for differences using Fisher's exact tests. Recurrence-free survival (RFS) was defined as the time between randomization and appearance of local or regional recurrence, metastases or death from any cause (Rodenhuis S, Bontenbal M, Beex L V et al. High-Dose Chemotherapy With Hematopoietic Stem-Cell Rescue for High-Risk Breast Cancer. N Engl J Med 2003; 349 (1): 7-16); all other events were censored. Overall survival (OS) was calculated from randomization to death from any cause, or end of follow-up. Patients alive at last follow-up were censored at that time. Median RFS and OS were 7.7 and 8.3 years, respectively, for all 249 patients. Survival analyses were performed using the Kaplan-Meier method for the making of curves and compared using log-rank tests; Cox regression methods were used to calculate hazard ratios (HR).

To ensure a direct correlation between aCGH pattern and treatment received, only patients who completed their assigned treatment were analyzed (per-protocol analysis). Whether the treatment effect on survival of HD-PB-chemotherapy compared to conventional chemotherapy, expressed as the HR, was significantly different between BRCA2-like CGH and non-BRCA2-like^{CGH} patients was assessed. This was evaluated with multivariate Cox regression analyses with an interaction term, adjusting for potential confounders.

To address non-proportionality of hazards, the Cox model was stratified for the number of lymph nodes (4-9 vs.>=10) and double negative ER/PR status (ER<10% and PR<10% vs. other). Regression coefficients for stratification variables were not explicitly estimated. Instead, separate baseline hazards were non-parametrically estimated for each combination of values of the stratification variables (4 strata). There was no evidence of non-proportional hazards in the stratified model, based on an evaluation using Schoenfeld residuals as well as interaction terms with follow-up time. In all models fitted during the evaluation of non-proportional hazards (different stratifications, time-interactions), the estimated effects for treatment, the BRCA2 classifier and their interaction were very stable (Therneau T M, Grambsch P M: Modeling survival data: extending the Cox model. Springer, New York 2000).

All calculations were performed using the statistical package SPSS 15.0 and SAS 9.1 (for Windows, respectively SAS Institute Inc., Cary, N.C., USA).

Results

Stage-III Series

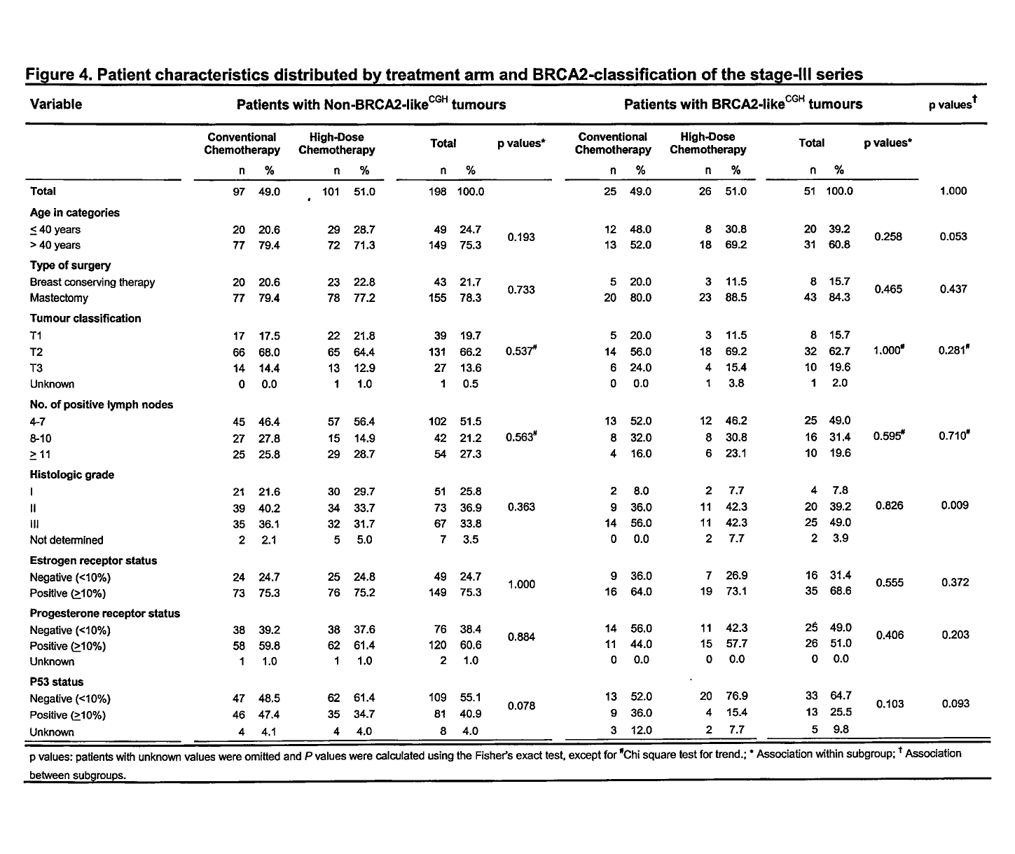

In total, for 249 patients an aCGH profile could be obtained. Characteristics and treatments of these 249 patients did not differ from those HER2-negative patients of the randomized controlled trial not in the current analysis (Table 5). Based on the aCGH tumor profiles, tumors of 51 patients (51/249, 20%) were scored as BRCA2-like^{CGH}. Within the patients with BRCA2- or non-BRCA2-like^{CGH} tumors patient characteristics did not differ by treatment arm (FIG. 4). Patients with BRCA2-like^{CGH} tumors were generally younger and their tumors were more often poorly differentiated (FIG. 4) compared to non-BRCA2-like^{CGH} patients.

TABLE 5
Distribution of clinicopathological variables between randomly sampled HER2-negative
patients and patients not in the current analysis from the stage-III series

| | | | In analysis with | | Not in current | | |
|---|---|---|---|---|---|---|---|
| | Total | | aCGH classifier | | analysis | | |
| Variable | n | (%) | n | (%) | n | (%) | p values* |
| Total | 592 | 100.0 | 249 | 42.1 | 343 | 57.9 | |
| Treatment | | | | | | | |
| Conventional chemotherapy | 298 | 50.3 | 122 | 49.0 | 176 | 51.3 | 0.618 |
| High Dose chemotherapy | 294 | 49.7 | 127 | 51.0 | 167 | 48.7 | |
| Age in categories | | | | | | | |
| ≦40 years | 153 | 25.8 | 69 | 27.7 | 84 | 24.5 | 0.393 |
| >40 years | 439 | 74.2 | 180 | 72.3 | 259 | 75.5 | |
| Type of surgery | | | | | | | |
| Breast conserving therapy | 135 | 22.8 | 51 | 20.5 | 84 | 24.5 | 0.276 |
| Mastectomy | 457 | 77.2 | 198 | 79.5 | 259 | 75.5 | |
| Tumor classification | | | | | | | |
| T1 | 136 | 23.0 | 47 | 18.9 | 89 | 25.9 | 0.222^{#} |
| T2 | 357 | 60.3 | 163 | 65.5 | 194 | 56.6 | |
| T3 | 90 | 15.2 | 37 | 14.9 | 53 | 15.5 | |
| Unknown | 9 | 1.5 | 2 | 0.8 | 7 | 2.0 | |
| No. of positive lymph nodes | | | | | | | |
| 4-7 | 289 | 48.8 | 127 | 51.0 | 162 | 47.2 | 0.458^{#} |
| 8-10 | 145 | 24.5 | 58 | 23.3 | 87 | 25.4 | |
| ≧11 | 158 | 26.7 | 64 | 25.7 | 94 | 27.4 | |
| Histologic grade | | | | | | | |
| I | 137 | 23.1 | 55 | 22.1 | 82 | 23.9 | 0.918 |
| II | 221 | 37.3 | 93 | 37.3 | 128 | 37.3 | |
| III | 217 | 36.7 | 92 | 36.9 | 125 | 36.4 | |
| Not determined | 17 | 2.9 | 9 | 3.6 | 8 | 2.3 | |
| Estrogen receptor status | | | | | | | |
| Negative (<10%) | 140 | 23.6 | 65 | 26.1 | 75 | 21.9 | 0.242 |
| Positive (≧10%) | 451 | 76.2 | 184 | 73.9 | 267 | 77.8 | |
| Unknown | 1 | 0.2 | 0 | 0.0 | 1 | 0.3 | |
| Progesterone receptor status | | | | | | | |
| Negative (<10%) | 213 | 36.0 | 101 | 40.6 | 112 | 32.7 | 0.081 |
| Positive (≧10%) | 368 | 62.2 | 146 | 58.6 | 222 | 64.7 | |
| Unknown | 11 | 1.9 | 2 | 0.8 | 9 | 2.6 | |
| P53 status | | | | | | | |
| Negative (<10%) | 331 | 55.9 | 142 | 57.0 | 189 | 55.1 | 0.861 |
| Positive (≧10%) | 225 | 38.0 | 94 | 37.8 | 131 | 38.2 | |
| Unknown | 36 | 6.1 | 13 | 5.2 | 23 | 6.7 | |

*p values: patients with unknown values were omitted and p values were calculated using the Fisher exact, except for
^{#}Chi square test for trend.; test.

Survival According to Treatment in Stage-III Series by BRCA2-Like^{CGH} Pattern

In the multivariate analyses, tumor size according to TNM classification, number of positive lymph nodes, Bloom Richardson grade (BR-grade), triple-negative status and treatment were included, since these variables were significantly associated with RFS in univariate analysis (Table 6).

TABLE 6
Univariate Cox proportional-hazard regression analysis of the risk
of Recurrence (RFS) after randomization in the stage-III series

| | No. Events/ | Hazard | | p |
|---|---|---|---|---|
| Variable | No. patients | Ratio | 95% CI | values |
| Age | | | | |
| Continuously | 112/249 | 0.99 | 0.97-1.02 | 0.695 |
| Type of surgery | | | | |
| Breast conserving therapy | 23/51 | 1.00 | | |
| Mastectomy | 89/198 | 0.98 | 0.62-1.55 | 0.934 |
| Pathological tumor | | | | |
| classification | | | | |
| T1 | 18/47 | 1.00 | | |
| T2 | 70/163 | 1.10 | 0.66-1.85 | 0.708 |
| T3 | 24/37 | 2.36 | 1.28-4.34 | 0.006 |
| No. of positive | | | | |
| lymph nodes | | | | |
| 4-7 | 52/127 | 1.00 | | |
| 8-10 | 23/58 | 0.98 | 0.60-1.60 | 0.937 |
| ≧11 | 37/64 | 1.80 | 1.18-2.74 | 0.006 |
| Histologic grade | | | | |
| I | 20/55 | 1.00 | | |
| II | 43/93 | 1.40 | 0.83-2.38 | 0.212 |
| III | 47/92 | 1.83 | 1.09-3.09 | 0.024 |
| Estrogen receptor status | | | | |
| Negative (<10%) | 34/65 | 1.00 | | |
| Positive (≧10%) | 78/184 | 0.57 | 0.38-0.86 | 0.008 |
| Progesterone receptor | | | | |
| status | | | | |
| Negative (<10%) | 49/101 | 1.00 | | |
| Positive (≧10%) | 62/146 | 0.71 | 0.49-1.04 | 0.076 |
| P53 status | | | | |
| Negative (<10%) | 66/142 | 1.00 | | |
| Positive (≧10%) | 40/94 | 0.91 | 0.62-1.35 | 0.648 |
| Treatment | | | | |
| Conventional | 68/122 | 1.00 | | |
| Chemotherapy | | | | |
| High Dose Chemotherapy | 44/127 | 0.50 | 0.34-0.73 | <0.001 |
| aCGH BRCA2-pattern | | | | |
| Non-BRCA2-like^{CGH} | 86/198 | 1.00 | | |
| tumor | | | | |
| BRCA2-like^{CGH} tumor | 26/51 | 1.28 | 0.83-1.99 | 0.266 |

Number of events is not equal for all variables, since some patients have missing data; maximum missing variables (i.e. events) is 6/112.
Abbreviations: CI, confidence interval.

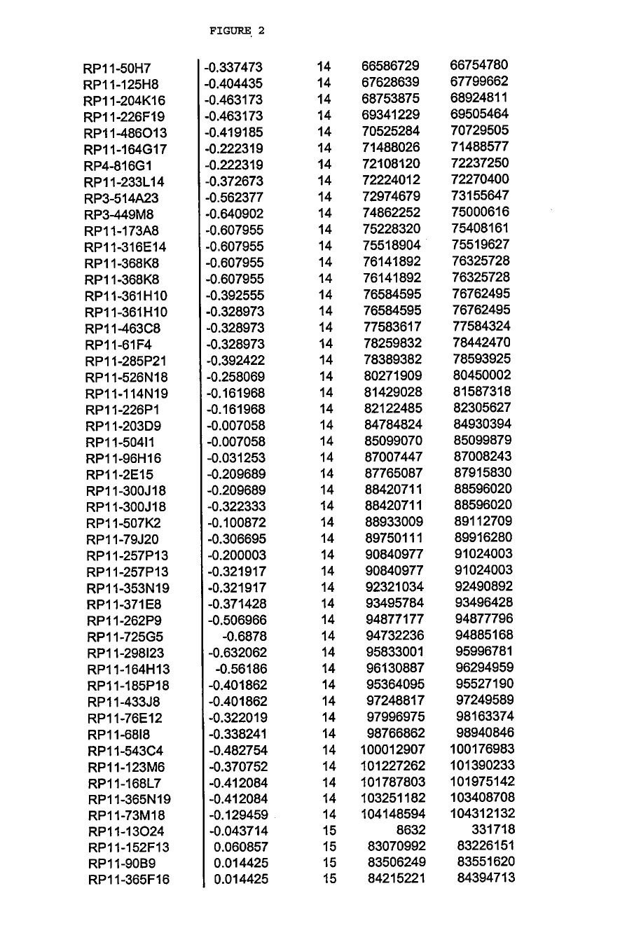

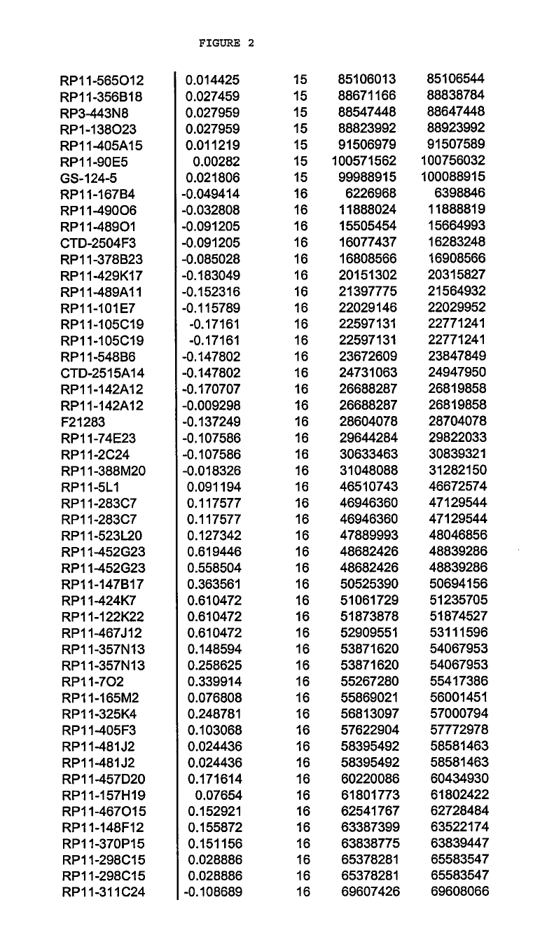

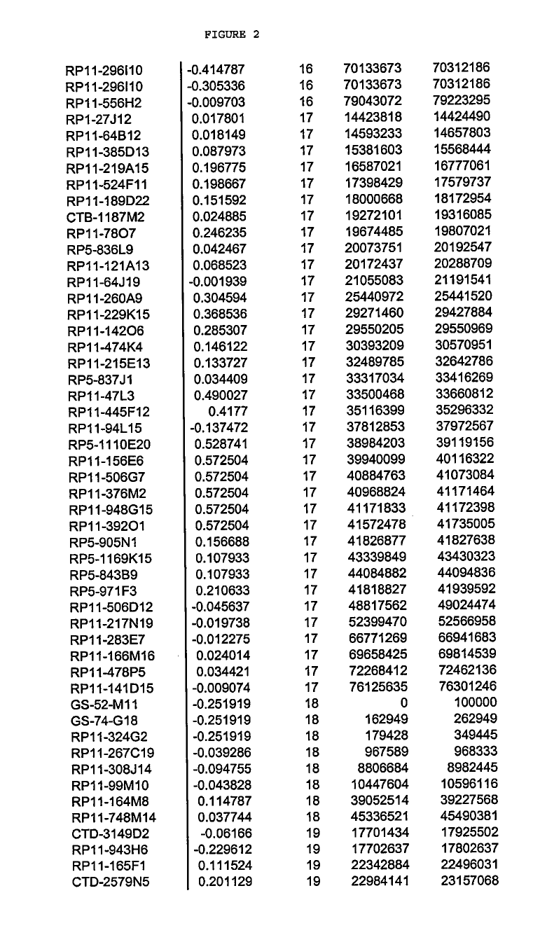

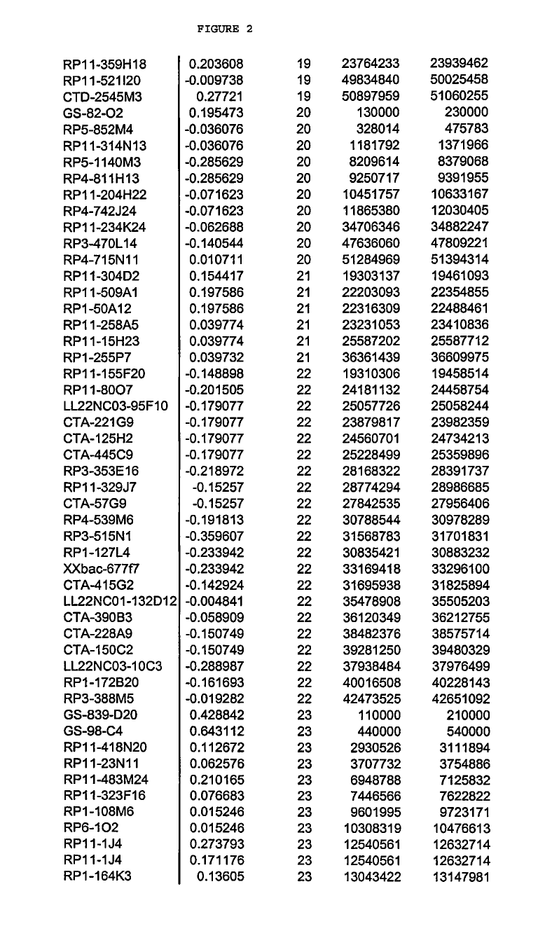

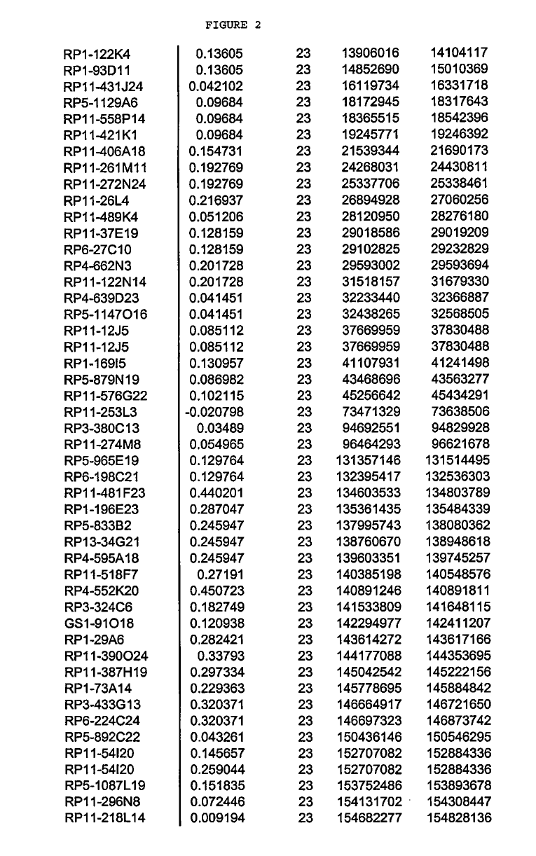

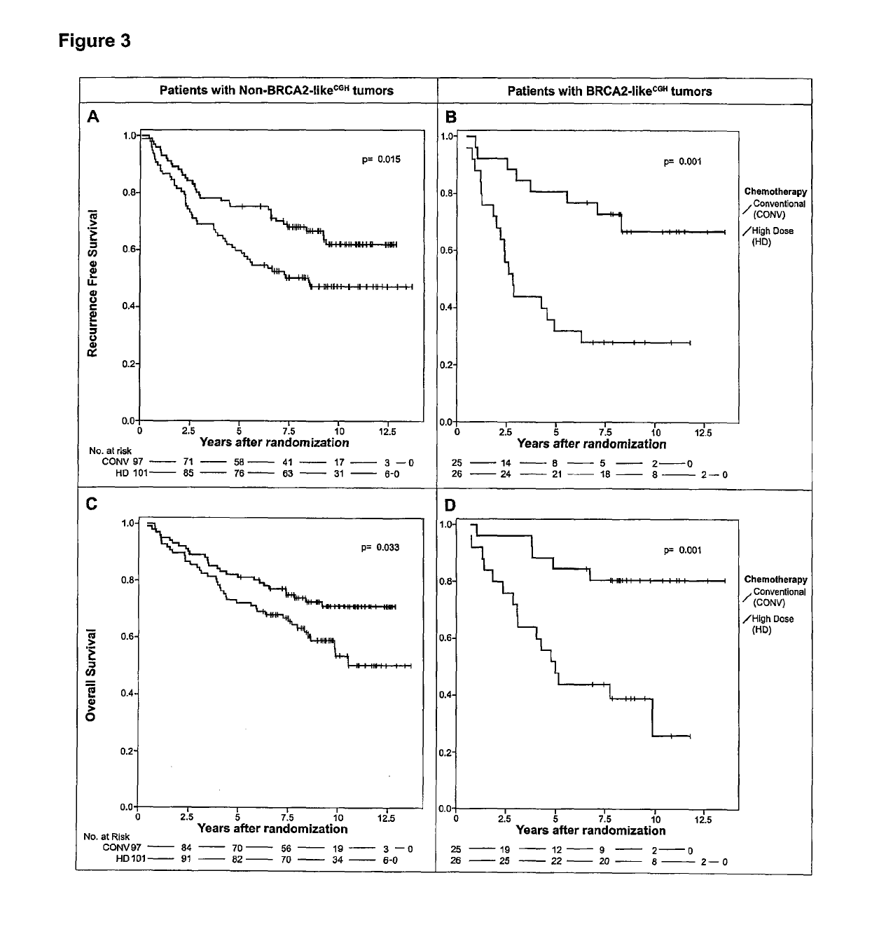

A significantly greater benefit of HD-PB-chemotherapy compared to conventional chemotherapy was observed with regard to RFS in patients with BRCA2-like^{CGH} tumors (FIG. 3 panel B, adjusted HR 0.22, 95% CI: 0.09-0.55; Table 7). In patients with non-BRCA2-like^{CGH} tumors this benefit was maintained although non-significantly (FIG. 3 panel A, adjusted HR 0.67, 95% CI: 0.44-1.04; Table 7). The difference observed between treatment arms was significantly different between patients with BRCA2-like^{CGH} tumor and non-BRCA2-like^{CGH} tumors (Table 7; p-interaction: 0.032). Similar results were obtained for overall survival (FIG. 3, panels C and D, p-interaction: 0.037; Table 8).

TABLE 7
Multivariate Cox proportional-hazard analysis of the risk of recurrence
(RFS) in the stage-Ill series and the BRCA2-classifier

| | No. Events/ | Hazard | | p |
|---|---|---|---|---|
| Variable | No. patients | Ratio | 95% CI | values |
| p T-stage | | | | |
| pT1 | 16/43 | 1.00 | | |
| pT2 | 69/157 | 1.01 | 0.58-1.76 | 0.967 |
| pT3 | 24/37 | 1.93 | 1.00-3.73 | 0.052 |
| Histologic grade | | | | |
| I | 20/55 | 1.00 | | |
| II | 43/92 | 1.15 | 0.66-2.01 | 0.622 |
| III | 46/90 | 1.65 | 0.91-2.99 | 0.101 |
| aCGH pattern | | | | |
| Non-BRCA2-like^{CGH} | 84/189 | 1.00 | | |
| tumour | | | | |
| BRCA2-like^{CGH} tumour | 25/48 | 1.90 | 1.06-3.42 | 0.032 |
| BRCA2-like^{CGH} tumour | | | | |
| Conventional chemotherapy | 18/25 | 1.00 | | |
| High-dose chemotherapy | 7/23 | 0.22* | 0.09-0.53 | 0.001 |
| Non-BRCA2-like^{CGH} | | | | |
| tumour | | | | |
| Conventional chemotherapy | 48/94 | 1.00 | | |
| High-dose chemotherapy | 36/95 | 0.65* | 0.42-1.01 | 0.056 |

Hazard ratios for high-dose vs. conventional chemotherapy differ significantly by BRCA2-like^{CGH} status (interaction p = 0.032). Cox model stratified for number of lymph nodes (4-9 vs. >=10) and double negative ER/PR status (ER < 10% and PR < 10% vs. other) and based on 237 patients (12 patients contributing 3 events were excluded due to missing values for at least one of the variables shown).
Abbreviations: No, number; CI, confidence interval.

TABLE 8
Multivariate Cox proportional-hazard analysis of the risk of
death (OS) in the stage-III series and the BRCA2-classifier

| | No. Events/ | Hazard | | p |
|---|---|---|---|---|
| Variable | No. patients | Ratio | 95% CI | values |
| p T-stage | | | | |
| pT1 | 14/43 | 1.00 | | |
| pT2 | 51/157 | 0.98 | 0.54-1.79 | 0.940 |
| pT3 | 22/37 | 2.11 | 1.06-4.22 | 0.035 |
| Histologic grade | | | | |
| I | 15/55 | 1.00 | | |
| II | 33/92 | 1.12 | 0.59-2.12 | 0.739 |
| III | 39/90 | 1.55 | 0.79-3.04 | 0.200 |
| aCGH pattern | | | | |
| Non-BRCA2-like^{CGH} | 67/189 | 1.00 | | |
| tumour | | | | |
| BRCA2-like^{CGH} tumour | 20/48 | 1.75 | 0.94-3.26 | 0.078 |
| BRCA2-like^{CGH} | | | | |
| Conventional chemotherapy | 16/25 | 1.00 | | |
| High-dose chemotherapy | 4/23 | 0.18* | 0.06-0.55 | 0.003 |
| Non-BRCA2-like^{CGH} | | | | |
| tumour | | | | |
| Conventional chemotherapy | 39/94 | 1.00 | | |
| High-dose chemotherapy | 28/95 | 0.67* | 0.41-1.11 | 0.118 |

Hazard ratios for high-dose vs. conventional chemotherapy differ significantly by BRCA2-like^{CGH} status (interaction p = 0.037). Cox model stratified for number of lymph nodes (4-9 vs. >=10) and double negative ER/PR status (ER < 10% and PR < 10% vs. other) and based on 237 patients (12 patients contributing 3 events were excluded due to missing values for at least one of the variables shown).
Abbreviations: No, number; CI, confidence interval.

Discussion

In this Example, a BRCA2-like^{CGH} pattern, a genomic pattern originated from BRCA2-mutated tumors, was investigated. We observed that patients with a BRCA2-like^{CGH} tumor had a significant better recurrence-free and overall survival after HD-PB-chemotherapy compared to anthracycline-based conventional chemotherapy, while this was not observed for patients with non-BRCA2-like^{CGH} tumors (significant p-interactions, RFS and OS). These data suggest that the BRCA2-like^{CGH} pattern is a predictive marker for HD-PB-chemotherapy benefit.

Tumors with a BRCA2-like^{CGH} pattern displayed a similar distribution of hormone-receptor negativity (16/51, 31%) as BRCA2-mutated breast cancers and as the general breast cancer population (Lakhani S R, van de Vijver M J, Jacquemier J et al. The Pathology of Familial Breast Cancer: Predictive Value of Immunohistochemical Markers Estrogen Receptor, Progesterone Receptor, HER-2, and P53 in Patients With Mutations in BRCA1 and BRCA2. J Clin Oncol 2002; 20 (9): 2310-2318; Palacios J, Honrado E, Osorio A et al. Phenotypic Characterization of BRCA1 and BRCA2 Tumors Based in a Tissue Microarray Study With 37 Immunohistochemical Markers. Breast Cancer Res Treat 2005; 90 (1): 5-14). In a previous report regarding the BRCA1-like^{CGH} pattern, it was observed that 25% of the BRCA1-like^{CGH} tumors harbored a BRCA1-mutation (Vollebergh, M. A., Lips E. H., Nederlof, P. M., et al. An aCGH classifier derived from BRCA1-mutated breast cancer and benefit of high-dose platinum-based chemotherapy in HER2-negative breast cancer patients, Ann Oncol, 2010, in press). An additional one-third of these BRCA1-like^{CGH} tumors showed hypermethylation of the BRCA1-promoter, a plausible cause for a disturbed BRCA1-pathway other than mutations. A similar strategy was used in a recent publication in which a profile for BRCAness was developed using BRCA1/2-mutated ovarian cancer, however that study used gene expression instead of aCGH (Konstantinopoulos P A, Spentzos D, Karlan B Y et al. Gene Expression Profile of BRCAness That Correlates With Responsiveness to Chemotherapy and With Outcome in Patients With Epithelial Ovarian Cancer. J Clin Oncol 2010). Sporadic ovarian cancer patients who scored as BRCAness (29%) with this profile showed a significantly longer disease-free survival after platinum agents.

In this Example a BRCA2-like^{CGH} classifier disclosed herein (FIG. 2) was used to identify HER2-negative patients with a selective improved outcome after HD-PB-chemotherapy, a DSB-inducing regimen. A variety of other methods have been applied to select patients benefiting from DSB-inducing agents, such as RAD51 staining (Asakawa H, Koizumi H, Koike A et al. Prediction of Breast Cancer Sensitivity to Neoadjuvant Chemotherapy Based on Status of DNA Damage Repair Proteins. Breast Cancer Res 2010; 12 (2): R17), gene expression profiling (Konstantinopoulos P A, Spentzos D, Karlan B Y et al. Gene Expression Profile of BRCAness That Correlates With Responsiveness to Chemotherapy and With Outcome in Patients With Epithelial Ovarian Cancer. J Clin Oncol 2010), methylation and BRCA1 gene expression measurement (Silver D P, Richardson A L, Eklund A C et al. Efficacy of Neoadjuvant Cisplatin in Triple-Negative Breast Cancer. J Clin Oncol 2010). These methods are based on an indirect link with either BRCA1 or BRCA2 as in the BRCAness phenotype concept described by Turner (Turner N, Tutt A, Ashworth A. Hallmarks of ‘BRCAness’ in Sporadic Cancers. Nat. Rev Cancer 2004; 4 (10): 814-819), as are the methods disclosed herein. However, most of the other studies performed to date were in triple negative (TN) breast cancer, as TN tumors share both histological and molecular features with BRCA1-mutated tumors (Lakhani S R, van de Vijver M J, Jacquemier J et al. The Pathology of Familial Breast Cancer: Predictive Value of Immunohistochemical Markers Estrogen Receptor, Progesterone Receptor, HER-2, and P53 in Patients With Mutations in BRCA1 and BRCA2. J Clin Oncol 2002; 20 (9): 2310-2318; Pathology of Familial Breast Cancer: Differences Between Breast Cancers in Carriers of BRCA1 or BRCA2 Mutations and Sporadic Cases. Breast Cancer Linkage Consortium. Lancet 1997; 349 (9064): 1505-1510). It is believes that BRCAness is not restricted to TN tumors, and thus this Example studied the BRCA2-like^{CGH} pattern which is also able to identify ER-positive tumors. This in contrast to the BRCA1-like^{CGH} pattern of which most tumors are TN (34/39, 87%) (Vollebergh, M. A., Lips E. H., Nederlof, P. M., et al. An aCGH classifier derived from BRCA1-mutated breast cancer and benefit of high-dose platinum-based chemotherapy in HER2-negative breast cancer patients, Ann Oncol, 2010, in press). By performing a randomized controlled trial, the selective benefit of platinum-based chemotherapy and general chemotherapy benefit could be distinguished by studying the association between aCGH patterns and survival.

Breast cancers are typically characterized by many large regions of genomic gains and losses that can readily be detected by aCGH arrays such as those disclosed herein. Another advantage of the methods disclosed herein is that they require only minimal amounts of DNA derived from FFPE tissue, which is a prerequisite for a clinical application in many jurisdictions.

In conclusion, in a series of 249 patients it was shown that a BRCA2-like^{CGH} classifier (FIG. 2) was able to both select ER-positive and TN breast cancer patients for selective benefit of intensified DSB-inducing chemotherapy. Patients with this BRCA2-like^{CGH} tumour phenotype had a five times lower risk of recurrence and death after the high-dose platinum-based chemotherapy than patients without this tumour phenotype. Therefore this BRCA2-like^{CGH} test can be used as a clinical chemotherapy prediction test.

Finally, it should be noted that there are alternative ways of implementing the embodiments disclosed herein. Accordingly, the present embodiments are to be considered as illustrative and not restrictive. Furthermore, the claims are not to be limited to the details given herein, and are entitled their full scope and equivalents thereof.

1. A method for predicting whether a patient will benefit from anti-cancer therapy, comprising:
obtaining a test sample from a patient;
detecting the copy numbers of DNA in the test sample in at least one genomic locus selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28; and
comparing the copy numbers in the test sample to corresponding copy numbers in a reference sample;
wherein a variation in the copy numbers in the test sample indicates that the patient will benefit from anti-cancer therapy.

2. The method of claim 1, wherein a variation in the copy numbers in the test sample is detected in at least one genomic locus selected from 4p13-12, 13q12.2-21.1, 13q31.3-33.1, 14q23.2-32.33, 16q12.1-21, 17q11.1-12 and 17q21.2-21.31.

3. The method of claim 1, wherein an increase in the copy numbers in the test sample in at least one genomic locus selected from 6p25.3-11.1, 6q12-13 and 13q31.3-33.1 indicates that the patient will benefit from anti-cancer therapy.

4. The method of claim 1, wherein a decrease in the copy numbers in the test sample in at least one genomic locus selected from 10q22.3-26.13, 13q12.2-21.1 and 14q23.2-32.33 indicates that the patient will benefit from anti-cancer therapy.

5. The method of claim 1, wherein a variation in the copy numbers in the test sample in at least one genomic locus selected from 13q12.2-21.1, 13q31.3-33.1 and 14q23.2-32.33 indicates that the patient will benefit from anti-cancer therapy.

6. The method of claim 1, wherein an increase in the copy numbers in the test sample in the genomic locus 13q31.3-33.1 indicates that the patient will benefit from anti-cancer therapy.

7. The method of claim 1, wherein a decrease in the copy numbers in the test sample in at least one genomic locus selected from 13q12.2-21.1 and 14q23.2-32.33 indicates that the patient will benefit from anti-cancer therapy.

8. The method of claim 1, wherein:
an increase in the copy numbers in the test sample is detected in at least one genomic locus selected from 6p25.3-11.1, 6q12-13 and 13q31.3-33.1;
a decrease in the copy numbers in the test sample is detected in at least one genomic locus selected from 10q22.3-26.13, 13q12.2-21.1 and 14q23.2-32.33;
an increase in the copy numbers in the test sample is detected in the genomic locus 13q31.3-33.1; and/or
a decrease in the copy numbers in the test sample is detected in at least one genomic locus selected from 13q12.2-21.1 and 14q23.2-32.33,
indicates that the patient will benefit from anti-cancer therapy.

9. The method of claim 1, wherein the anti-cancer therapy is selected from administration of homologous recombination deficiency-targeted drugs, drugs that directly cause double strand DNA breaks, and drugs that indirectly cause double strand DNA breaks.

10. The method of claim 1, wherein the detecting is performed by array comparative genomic hybridization using an array.

11. The method of claim 10, wherein the array comprises a plurality of probes immobilized on a substrate, wherein the probes hybridize to DNA from at least one genomic locus selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28.

12. The method of claim 11, wherein the probes hybridize to DNA from the genomic loci 6p25.3-11.1, 6q12-13 and 13q31.3-33.1.

13. (canceled)

14. The method of claim 11, wherein the probes hybridize to DNA from the genomic loci 10q22.3-26.13, 13q12.2-21.1 and 14q23.2-32.33.

15. (canceled)

16. The method of claim 11, wherein the probes hybridize to DNA from the genomic locus 13q31.3-33.1.

17. (canceled)

18. The method of claim 11, wherein the probes hybridize to DNA from the genomic loci 13q12.2-21.1 and 14q23.2-32.33.

19. (canceled)

20. The method of claim 11, wherein the probes hybridize to DNA from the genomic loci 6p25.3-11.1, 6q12-13, 13q31.3-33.1, 10q22.3-26.13, 13q12.2-21.1, 14q23.2-32.33, 13q31.3-33.1, 13q12.2-21.1 and 14q23.2-32.33.

21. (canceled)

22. The method of claim 11, wherein the array comprises a plurality of probes derived from at least one of the BAC clones of FIG. 2.

23. The method of claim 11, wherein the probes are derived from at least 50 of the BAC clones of FIG. 2.

24. The method of claim 11, wherein the probes are derived from all 704 of the BAC clones of FIG. 2.

25. The method of claim 11, wherein the detecting is performed prior to administration of the anti-cancer therapy.

26. A BRCA2 classifier, comprising:
a plurality of probes, wherein the probes hybridize to DNA from at least one genomic locus selected from 2p24.1-16.3, 2q36.3-37.1, 3p12.3-3q11.2, 4p13-12, 6p25.3-11.1, 6q12-13, 7q11.21-11.22, 7q35-36.3, 10p15.2-12.1, 10q22.3-26.13, 11p15.5-15.4, 11q13.2-14.2, 11q23.1-25, 13q12.2-21.1, 13q31.3-33.1, 14q12-21.2, 14q23.2-32.33, 16p12.3-11.2, 16q12.1-21, 17p12-11.2, 17q11.1-12, 17q21.2-21.31, 22q11.23-13.1, 23p22.33-11.3 and 23q26.2-28; and
wherein the probes detect a variation in copy number of the DNA from the at least one genomic locus.

27-30. (canceled)

31. The classifier of claim 26, wherein the probes hybridize to DNA from the genomic loci 6p25.3-11.1, 6q12-13, 13q31.3-33.1, 10q22.3-26.13, 13q12.2-21.1, 14q23.2-32.33, 13q31.3-33.1, 13q12.2-21.1 and 14q23.2-32.33.

32-34. (canceled)
